(19) United States
(12) Patent Application Publication
(10) Pub. No.: US 2006/0107267 A1
(43) Pub. Date: May 18, 2006

(54) Instruction scheduling method

(75) Inventors: Ryoko Miyachi, Nishinomiya-shi (JP); Hajime Ogawa, Suita-shi (JP); Tomoo Hamada, Ibaraki-shi (JP); Teruo Kawabata, Suita-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/270,515

(22) Filed: Nov. 10, 2005

(30) Foreign Application Priority Data
Nov. 12, 2004 (JP) 2004-328828

(51) Int. Cl. G06F 9/46

(52) U.S. Cl. 718/100

(57) ABSTRACT

An instruction scheduling method according to the present invention allocates each instruction included in an instruction sequence to be synthesized as a circuit to one of execution cycles in the circuit, and includes: detecting a freedom of each instruction, the freedom representing a time period within which the instruction can be allocated; calculating a load of a processing element corresponding to the instruction for each of the execution cycles; and allocating the instructions using the same processing element within the freedoms to different execution cycles based on the load.

### BACKGROUND OF THE INVENTION

(1) Field of the Invention

The present invention relates to an instruction scheduling method for placing each instruction included in an instruction sequence to be synthesized as a circuit in an execution cycle of the circuit.

(2) Description of the Related Art

Execution efficiency of conventional high-level synthesis compilers has been improved by various parallelizing technologies to execute a plurality of instructions in an execution cycle, such as a software pipelining technology. However, a total number of required execution cycles cannot be estimated until the compilation completes. Moreover, although various optimizations are performed to improve the execution efficiency, not many optimizations aim to reduce circuit area and power consumption.

One example of the above technologies is disclosed in “Force-directed scheduling in automatic data path synthesis,” (P. G. Paulin and J. P. Knight, Proc. 24th Design Automation Conference, pp. 195-202, 1987.) in which a force-directed scheduling is proposed as an instruction scheduling method for improving reusability of a processing element.

However, the conventional high-level synthesis compilers aim to improve only the execution efficiency, eventually improving the execution efficiency more than necessary but at the same time having a high possibility of increase of circuit area and power consumption.

More specifically, in a case where there are different types of processing elements having the same function, one of which is a high-speed processing element with a short latency (execution delay) but with a large circuit size and high power consumption, and the other of which is a low-speed processing element with a large execution delay but with a small circuit size and low power consumption, the conventional technologies sometimes do not select one of the processing elements based on a required frequency (or cycle time), and eventually increase the execution efficiency more than necessary. In addition, there is a case an execution time period (latency) executed by the processing element is much shorter than a time period in one cycle, wasting the time period in the cycle.

Accordingly, the conventional technologies can improve execution efficiency of a circuit, but at the same time increase the execution efficiency more than necessary, thereby causing problems of increasing costs for a circuit size increase and high power consumption (hereinafter, referred to as “costs due to operation execution speed”).

For example, in hardware designing for executing audio and visual data processing, the number of execution cycles is predetermined to be allocated to each module, so that it is necessary to design the most appropriate circuit to satisfy the constraints of the execution cycle number and at the same time consider the number of the processing elements and the costs due to operation execution speed.

### SUMMARY OF THE INVENTION

The present invention aims to solve the above problems, and an object of the present invention is to provide an instruction scheduling method which balances between minimum necessary execution efficiency and reduction of circuit area and power consumption.

Another object of the present invention is to provide an instruction scheduling method which satisfies execution efficiency (frequency or the number of execution cycles) required by a user and at the same time reduces number of used processing elements and costs due to operation execution speed.

In order to solve the above problems, an instruction scheduling method according to the present invention for allocating each instruction included in an instruction sequence to be synthesized as a circuit to one of execution cycles in the circuit, includes: detecting a freedom of each instruction, the freedom representing a time period within which the instruction can be allocated; calculating a load of a processing element corresponding to the instruction for each of the execution cycles; and allocating the instructions using the same processing element within the freedoms to different execution cycles based on the load.

With the above structure, instructions using the same processing element are allocated to different cycles in the processing element, thereby increasing reusability of the processing element to be used by a plurality of instructions, reducing the number of used processing elements, and increasing usability of an processing element such as an processing element with a low operation execution speed and a low cost by the allocation based on the load, so that it is possible to balance the minimum necessary execution efficiency and the reduction of circuit area and power consumption.

Here, the instruction scheduling method may further include determining number of the execution cycles in which the instruction sequence is allocated by receiving a user's designation of number of the execution cycles.

With the above structure, the present invention has characteristics in that the scheduling is performed based on the execution efficiency (frequency or the number of execution cycles) required by the user, so that it is possible to form the most appropriate circuit which satisfies the execution efficiency required by the user and at the same time has small circuit area and low power consumption without increasing the circuit area and the power consumption in order to increase the execution efficiency more than necessary.

Here, the instruction scheduling method may further include determining number of the execution cycles in which the instruction sequence is allocated by receiving a user's designation of number of the execution cycles.

With the above structure, if there are processing elements to be used whose number is predetermined, such processing elements are used at a maximum number, so that it is possible to reduce the number of used processing elements and costs due to operation execution speed regarding other processing elements.

Here, the instruction scheduling method may further include receiving, on a type of the processing element, a designation of a limited number of the processing elements, wherein in the allocating, the instruction is allocated in the processing element whose number is within the limited number.

With the above structure, the limited number of used processing elements having large circuit area and power consumption is imposed, so that it is possible to prevent increase of circuit area and power consumption.

Here, the instruction scheduling method may further include receiving a user's designation of a processing element whose cost is to be reduced, wherein in the allocating, an instruction using the processing element designated by the user is allocated as a priority.

With the above structure, a processing element, such as a processing element with large circuit area and power consumption, which the user designates to reduce especially the number of the processing element and costs due to operation execution speed is allocated as a priority, so that it is possible to reduce a usage number of the processing element and the costs due to operation execution speed.

Here, the instruction scheduling method may further include receiving a user's designation of a priority of the processing element whose cost is to be reduced, wherein in the allocating, an instruction using the processing element is allocated in order of the designated priority.

With the above structure, by setting priorities of processing elements which the user designates to reduce especially the number of the processing elements and costs due to operation execution speed, it is possible to ensure the reduction for processing elements with high priorities.

Here, the instruction scheduling method may further include selecting as a priority, based on a user's designation, one of number of used processing elements and a cost due to operation execution speed increase in order to be reduced, wherein in the calculating, a first load of the number of used processing elements and a second load of the cost due to operation execution speed increase are calculated, and in the allocating, the instruction using the processing element is allocated in order to reduce the selected load as a priority from the first load and the second load.

With the above structure, the present invention has characteristics in that the user can select which is reduced as a priority, the number of used processing elements or the costs due to operation execution speed, so that it is possible to form the most appropriate circuit based on a type of the instruction sequence to be scheduled whether the type is a data path type or a pipelined type.

Furthermore, an instruction scheduling method for allocating each instruction included in an instruction sequence to be synthesized as a circuit to one of execution cycles in the circuit, includes: obtaining number of the execution cycles as execution efficiency of the circuit which is designated by a user; creating a directed acyclic graph which indicates interdependencies among the instructions included in the instruction sequence; and allocating each instruction to one of the execution cycles in order to satisfy the designated execution efficiency and to reduce number of processing elements and a cost due to operation execution speed increase, wherein in the allocating includes: determining a scheduling time range which represents a total number of the execution cycles in which the instruction sequence to be scheduled is to be allocated based on the execution efficiency; setting, on a type of the processing element, a target number of the processing elements; calculating a freedom of each instruction, the freedom representing a time period within which the instruction can be allocated within the scheduling time range based on a directed acyclic graph; calculating a load of the processing element for each of the execution cycles; and allocating each instruction to one of the execution cycles by determining an allocating time of the instruction within the freedom based on the target number of the processing elements and the calculated load.

With the above structure, the instruction to be scheduled is inserted in the most appropriate time period within the range of freedom range in order to reduce the number of used processing elements and the costs due to operation execution speed, so that it is possible to form a circuit with small circuit area and low power consumption.

Here, in the determining, the number of the execution cycles which is designated by the user may be determined as the scheduling time range.

With the above structure, it is possible to form the most appropriate circuit for executing the instruction sequence to be scheduled with the number of cycles designated by the user.

Here, the setting, for a certain type processing element of whose number is not designated by the user, the target number of the processing elements may be obtained by dividing a total number of instructions using the by number of the execution cycles in the scheduling time range and then converting the divided value into an integer value.

With the above structure, it is possible to easily determine which instruction should be allocated at which time in order to increase reusability of the processing element.

Here, in the setting, number of certain type processing elements whose number may be designated by the user is set to as the target number of the processing elements.

With the above structure, it is possible to prevent an unnecessary increase of reusability of processing elements whose number is predetermined.

Here, in the calculating of the load, a processing element number load and a minimum operation execution speed load may be calculated, the processing element number load being an index for calculating an instruction allocating time in order to reduce the number of the processing elements, and the minimum operation execution speed load being an index for calculating an instruction allocating time in order to reduce the cost due to operation execution speed increase.

With the above structure, by using two types of loads, it is possible to form a circuit which balances the minimum necessary execution efficiency and the reduction of circuit area and power consumption.

Here, the minimum operation execution speed load may be equivalent to an inverse number of a value of a maximum time period which is available to execute an instruction, in a case where the instruction is allocated in an execution cycle whose minimum operation execution speed load is to be calculated.

With the above structure, it is possible to easily determine, based on the minimum execution speed load, which instruction should be allocated at which time in order to form a circuit with low power consumption.

Here, in the allocating, the allocating time may be determined firstly for an instruction which uses a processing element whose processing element number load may be larger than the target number of the processing elements in order to reduce number of the processing elements used in the whole instruction sequence.

With the above structure, it is possible to definitely reuse a processing element to be reused.

Here, in the allocating, the freedom is changed firstly for an instruction which is selected from the instructions which use processing elements whose processing element number load is larger than the target number of the processing elements, based on a priority of the following conditions (a) and (b): the conditions (a), in a case where an execution cycle whose processing element number load is larger than the target number of the processing elements is defined as an execution cycle for which the load is to be reduced and there is an instruction which has a possibility of being allocated in an execution cycle prior to the execution cycle, defining

(Priority 1) an instruction whose height is the highest,

(Priority 2) an instruction with a maximum number of child nodes,

(Priority 3) an instruction whose depth is the narrowest,

(Priority 4) an instruction with a minimum number of parent nodes, and

(Priority 5) an instruction with a minimum directed acyclic graph node identification; and

the conditions (b), in a case where there is no instruction which has a possibility of being allocated in an execution cycle prior to the execution cycle by which the load is to be reduced, defining

(Priority 1) an instruction whose height is the lowest,
(Priority 2) an instruction with a minimum number of child nodes,
(Priority 3) an instruction whose depth is the deepest,
(Priority 4) an instruction with a maximum number of parent nodes, and
(Priority 5) an instruction with a maximum directed acyclic graph node identification.

With the above structure, an instruction to be allocated at an early time and an instruction to be allocated at a late time are correctly selected, so that it is possible to prevent, excluding, from a freedom, a cycle in which number of used processing elements can be reduced by other instructions, as a result of changing the freedom of the instruction.

Here, in the allocating, in a case where an instruction whose freedom is firstly changed has a possibility of being allocated in an execution cycle prior to the execution cycle whose load is to be reduced, the freedom of the instruction may be changed so that the instruction is allocated in an execution cycle immediately prior to the execution cycle whose load is to be reduced, and in a case where the instruction whose freedom is firstly changed does not a possibility of being allocated in an execution cycle prior to the execution cycle whose load is to be reduced, the freedom of the instruction may be changed so that the instruction is allocated in an execution cycle immediately subsequent to the execution cycle whose load is to be reduced.

With the above structure, it is possible to correctly set the changed freedom in order to prevent excluding, from the freedom, a cycle in which number of used processing elements can be reduced.

Here, in the allocating, in a case where an instruction whose freedom is firstly changed has a possibility of being allocated in an execution cycle prior to the execution cycle whose load is to be reduced, the freedom of the instruction may be changed so that the instruction is allocated in an execution cycle immediately prior to the execution cycle whose load is to be reduced, and in a case where the instruction whose freedom is firstly changed does not a possibility of being allocated in an execution cycle prior to the execution cycle whose load is to be reduced, the freedom of the instruction may be changed so that the instruction is allocated in an execution cycle immediately subsequent to the execution cycle whose load is to be reduced.

With the above structure, it is possible to easily determine which instruction should be allocated at which time in order to reduce power consumption of the processing element.

Here, the instruction scheduling method may further include rewriting two instructions in order to transfer a result of executing one instruction to another instruction without storing the result in a register, in a case where the result of executing the one instruction is used for the another instruction in a same execution cycle based on a result of the allocating of the instructions.

With the above structure, it is possible to reduce the number of registers in the circuit.

Still further, an instruction scheduling device, a circuit synthesizing method, a circuit synthesizing device and a program for executing those devices and methods according to the present invention have the same advantages and effects as described above.

The present invention performs scheduling to satisfy execution efficiency designated by the user and at the same time to reduce averagely a usage number of processing elements (by type) and costs due to operation execution speed, thereby improving reusability of a processing element and utilization of a low-cost processing element. Thus, it is possible to reduce circuit area and power consumption.

Further Information about Technical Background to this Application

As further information about technical background to this application, Japanese Patent Application No. 2004-328828 filed on Nov. 12, 2004 is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of a high-level synthesis compiler according to a preferred embodiment of the present invention;

FIG. 2A is a diagram showing one example of an instruction sequence P2 to be scheduled;

FIG. 2B is a diagram showing one specific example of a directed acyclic graph (DAG) generated by a DAG generation unit;

FIG. 3 is a flowchart showing an instruction placing time detecting step in detail;

FIG. 4 is a flowchart showing a scheduling time range detecting step in detail;

FIG. 5 is a flowchart showing a freedom detecting step in detail;

FIG. 6 is a flowchart showing ASAP time detecting processing;

FIG. 7 is a flowchart showing ALAP time detecting processing;

FIG. 8 is an explanatory diagram showing ASAP times;

FIG. 9 is an explanatory diagram showing ALAP times;

FIG. 10 is an explanatory diagram showing freedoms in placements of respective instructions;

FIG. 11 is a flowchart showing a used processing element number load detecting step in detail;

FIG. 12 is a flowchart showing a minimum execution speed load detecting step in detail;

FIG. 13 is a diagram showing a specific example of used processing element number loads and minimum execution speed loads;

FIG. 14 is a flowchart showing a load reduction instruction placing time detecting step in detail;

FIG. 15 is a flowchart showing a placing time detecting step to reduce the number of used processing elements first as a priority;

FIG. 16 is a flowchart showing a placing time detecting step to reduce the costs due to operation execution speed first as a priority;

FIG. 17 is a flowchart showing used processing element load reducing processing;

FIG. 18 is a flowchart showing execution speed load reducing processing;

FIG. 19A is a diagram showing a specific example of processing for detecting a load reduction instruction placing time, in a case where the number of used processing elements is reduced as a priority;

FIG. 19B is a diagram showing the specific example of processing for detecting a load reduction instruction placing time, in a case where the number of used processing elements is reduced as a priority;

FIG. 19C is a diagram showing the specific example of processing for detecting a load reduction instruction placing time, in a case where the number of used processing elements is reduced as a priority;

FIG. 19D is a diagram showing the specific example of processing for detecting a load reduction instruction placing time, in a case where the number of used processing elements is reduced as a priority;

FIG. 19E is a diagram showing the specific example of processing for detecting a load reduction instruction placing time, in a case where the number of used processing elements is reduced as a priority;

FIG. 20A is a diagram showing a specific example of processing for detecting a load reduction instruction placing time, in a case where the costs due to operation execution speed is reduced as a priority;

FIG. 20B is a diagram showing the specific example of processing for detecting a load reduction instruction placing time, in a case where the costs due to operation execution speed is reduced as a priority;

FIG. 20C is a diagram showing the specific example of processing for detecting a load reduction instruction placing time, in a case where the costs due to operation execution speed is reduced as a priority;

FIG. 21A is a diagram showing a result of the scheduling in a case where the number of used processing elements is reduced as a priority, and in a case where the costs due to operation execution speed is reduced as a priority;

FIG. 21B is the result of the scheduling; and

FIG. 22 is a block diagram showing a formed circuit.

### DESCRIPTION OF THE PREFERRED EMBODIMENT(S)

The following describes a high-level synthesis compiler including an instruction scheduling device according to a preferred embodiment of the present invention with reference to the drawings.

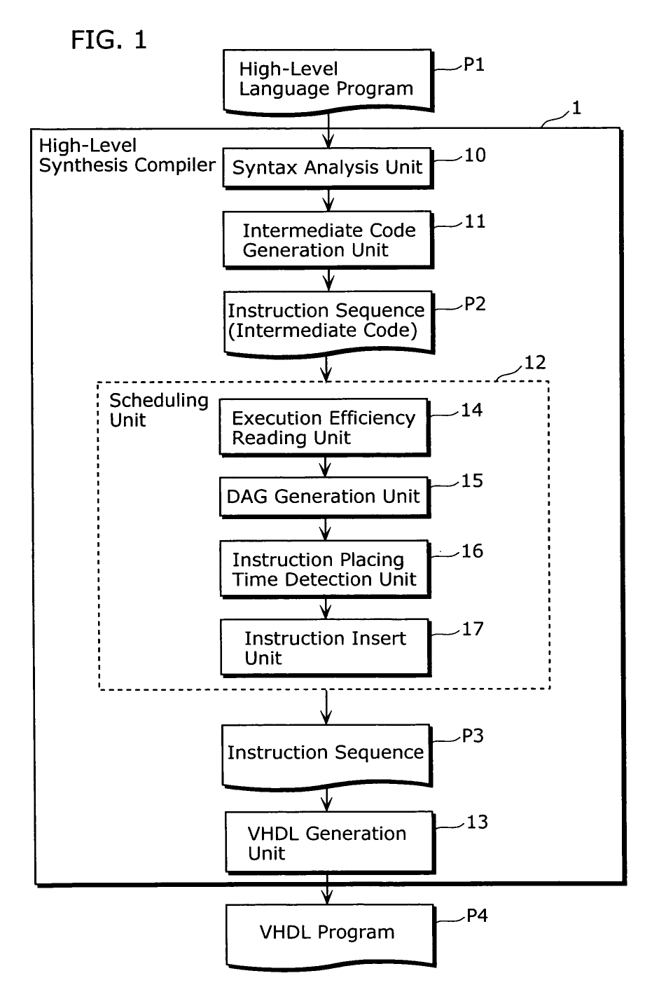

FIG. 1 is a block diagram showing a structure of the high-level synthesis compiler according to the preferred embodiment of the present invention.

Referring to FIG. 1, a high-level synthesis compiler 1 includes a syntax analysis unit 10, an intermediate code generation unit 11, a scheduling unit 12, and a VHDL generation unit 13.

The high-level synthesis compiler 1 forms a circuit by using a program described in a high-level language. Note that the high-level language program is, for example, a C language. Note also that the circuit is a program describing a hardware configuration, such as a circuit describing program at register/transfer level described in a very-high-speed integrated (VHSIC) hardware description language (VHDL).

The syntax analysis unit 10 analyzes a syntax of a high-level language program P1, such as a C language program.

The intermediate code generation unit 11 generates an instruction sequence P2 as an intermediate code by replacing the high-level language program P1 with an intermediate instruction (hereinafter, referred to as just “instruction”) based on the analysis result.

The scheduling unit 12 receives the instruction sequence P2 to be scheduled, and generates an instruction sequence P3 which is scheduled to satisfy execution efficiency (frequency or the number of execution cycles required by a user and at the same time to form a circuit with small circuit area and low power consumption. Note that the scheduling represents determining which instruction should be placed (or allocated) in which cycle among a plurality of the execution cycles allocated to the circuit to be formed. The scheduling unit 12 places instructions using the same processing element into separate cycles in the processing element within a range of satisfying the execution efficiency (frequency or the number of execution cycles) required by the user, and appropriately moves instructions having interdependencies into different cycles in order to give an average freedom to an execution time period in each cycle which executes the instruction. Thereby reusability of the processing element is improved to reduce the number of used processing elements (hereinafter, referred to as “used processing element number”), and also usability of a processing element with low operation execution speed and cost.

The VHDL generation unit 13 generates a VHDL program from the instruction sequence scheduled by the scheduling unit 12.

Moreover, the scheduling unit 12 of FIG. 1 includes an execution efficiency reading unit 14, a DAG generation unit 15, an instruction placing time detection unit 16, and an instruction insert unit 17.

The execution efficiency reading unit 14 reads, from the outside or a predetermined file, execution efficiency (frequency or the number of the execution cycles) designated by the user regarding an instruction sequence to be scheduled.

The DAG generation unit 15 generates a directed acyclic graph (hereinafter, referred to as DAG) indicating interdependencies among instructions in the instruction sequence P2 to be scheduled.

The instruction placing time detection unit 16 calculates a placing time of each instruction within a scheduling time range, in order to satisfy the execution efficiency read by the execution efficiency reading unit 14 and at the same time to reduce the used processing element number and costs due to operation execution speed. Note that the scheduling time range represents the number of cycles allocated to a circuit corresponding to the instruction sequence P2. Note also that the instruction placing time represents a time within the scheduling time range. The time is indicated by, for example, a cycle and a delayed time calculated from a start of the cycle.

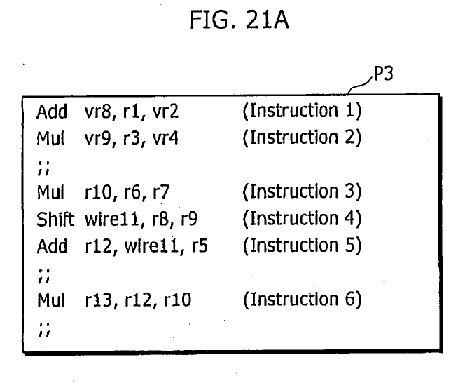

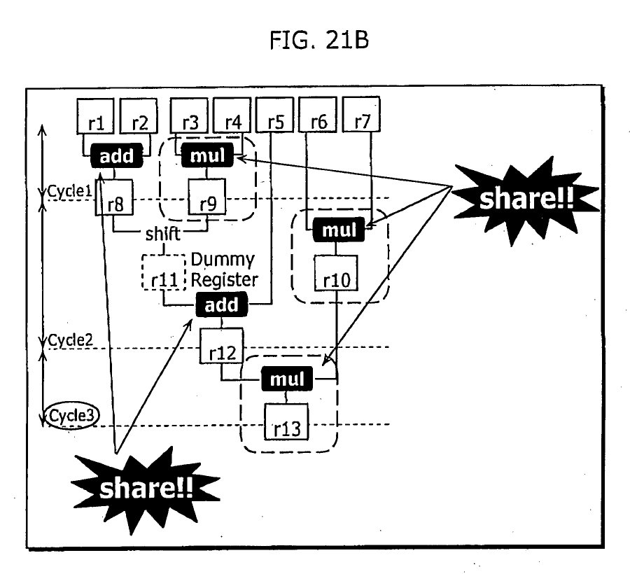

The instruction insert unit 17 inserts an instruction at the time calculated by an instruction placing time detection step. More specifically, the instruction insert unit 17 inserts the instruction between marks (“;;”, for example) representing a split between cycles (see FIG. 21A), in order to distinguish the instructions executed in the same cycle, and in a case where an executed result of the instruction is used for another instruction in the same cycle, rewrites the two instructions to transfer the executed result into another instruction in the same cycle without storing the executed result into a register.

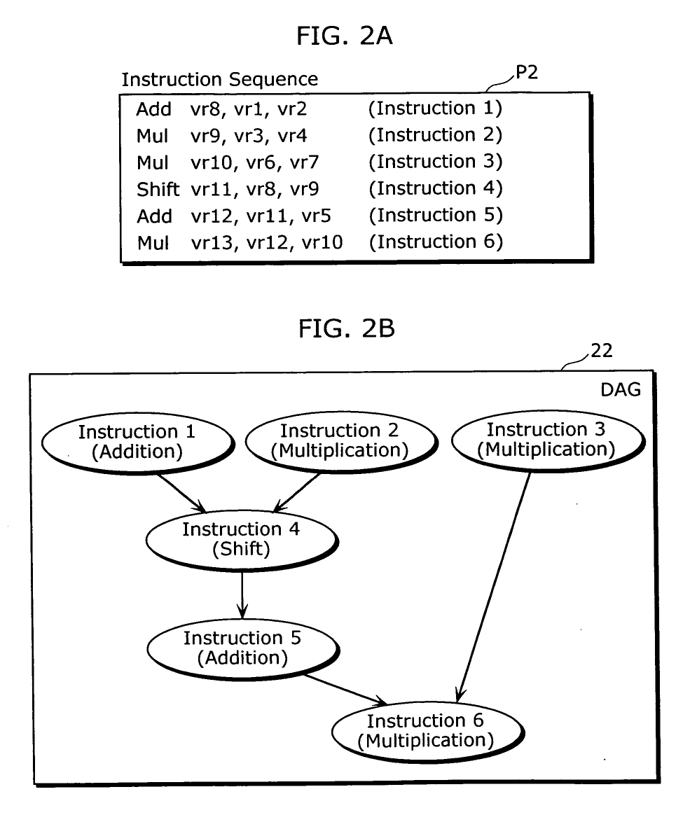

FIG. 2A is a diagram showing one example of the instruction sequence P2 to be scheduled.

Here, instructions 1 to 6 indicated in the instruction sequence P2 are described.

The instruction 1 adds data stored in a virtual register vr1 with data stored in a virtual register vr2, and stores the addition result into a virtual register vr8.

The instruction 2 multiplies data stored in a virtual register vr3 by data stored in a virtual register vr4, and stores the multiplication result into a virtual register vr9.

The instruction 3 multiplies data stored in a virtual register vr6 by data stored in a virtual register vr7, and stores the multiplication result into a virtual register vr10.

The instruction 4 shifts the executed result of the instruction 1 (addition) stored in the virtual register vr8 based on the result of the instruction 2 (multiplication) stored in the virtual register vr9, and stores the shift result into a virtual register vr11. Thus, the instruction 4 (shift) depends on the instruction 1 (addition) and the instruction 2 (multiplication).

The instruction 5 adds the executed result of the instruction 4 (shift) stored in the virtual register vr11 with the data stored in a virtual register vr5, and stores the addition result into a virtual register vr12. Thus, the instruction 5 (addition) depends on the instruction 4 (shift).

The instruction 6 multiplies the executed result of the instruction 5 (addition) stored in the virtual register vr12 by the executed result of the instruction 3 (multiplication) stored in the virtual register vr10, and stores the multiplication result into a virtual register vr13. Thus, the instruction 6 (multiplication) depends on the instruction 5 (addition) and the instruction 3 (multiplication).

FIG. 2B is a diagram showing a specific example of the DAG generated for the instruction sequence P2 by the DAG generation unit 15.

In a DAG 22, independent instructions (parent nodes) and dependent instructions (child nodes) are linked in directions indicated by arrows.

More specifically, each arrow links: the instruction 1 (addition) to the instruction 4 (shift); the instruction 2 (multiplication) to the instruction 4 (shift); the instruction 4 (shift) to the instruction 5 (addition); the instruction 5 (addition) to the instruction 6 (multiplication); and the instruction 3 (multiplication) to the instruction 6 (multiplication).

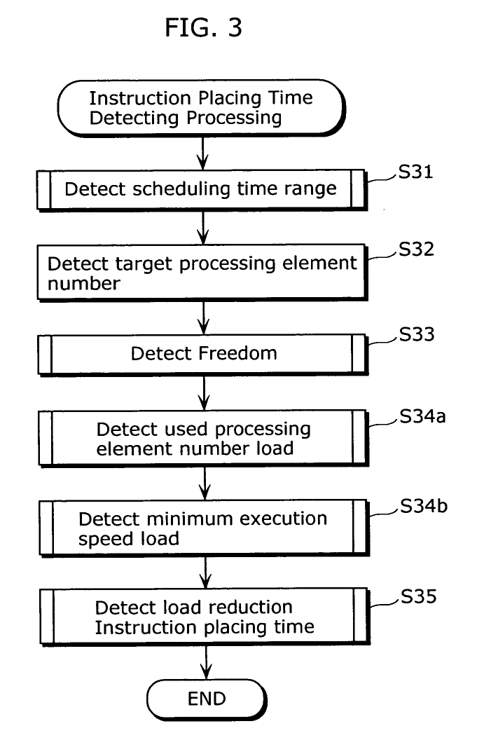

FIG. 3 is a flowchart showing instruction placing time detecting processing performed by the instruction placing time detection unit 16 in detail.

Step S31 is a scheduling time range detecting step for calculating a time range (the number of cycles) in which an instruction sequence to be scheduled is placed.

Step S32 is a target processing element number detecting step for calculating a target used processing element number per type. It is assumed that a target processing element number regarding processing elements whose used number is designated by the user is equivalent to the used processing element number. Moreover, a target processing element number regarding processing elements whose used number is not designated by the user is calculated by the following equation 1;
Target processing element number=ceil(x) (Number of instructions using the processing element/Scheduling time range) [equation 1].

Note that ceil(x) represents a ceiling function and derives a minimum integer more than the argument x.

The equation 1 indicates that a total number of instructions using a processing element whose target processing element number is to be calculated is divided by a scheduling time range (the number of cycles) to obtain an argument of a ceiling function, which is equivalent to a target processing element number.

Step S33 is a freedom detecting step for detecting, for each instruction to be scheduled, a time range (freedom) in which the instruction can be placed in the scheduling time range.

Step S34a is a detecting step for detecting a used processing element number load which is an index indicating the number of processing elements used in each cycle.

Step S34b is a detecting step for detecting a minimum execution speed load which is an index indicating costs due to operation execution speed.

Step S35 is a load reduction instruction placing time detecting step for detecting, based on the loads detected by the load detecting steps, an instruction placing time within the freedom in order to reduce circuit area and power consumption.

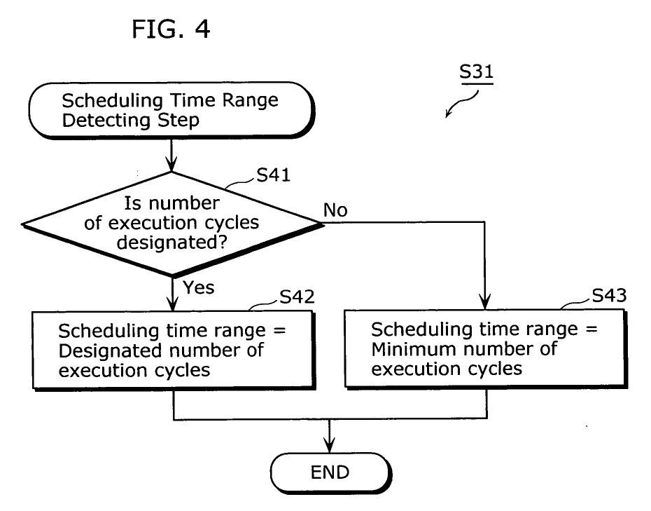

Firstly, the scheduling time range detecting step (S31) is described with reference to FIG. 4.

FIG. 4 is a flowchart showing the scheduling time range detecting step in detail.

At Step S41, a determination is made as to whether or not the number of execution cycles for an instruction sequence to be scheduled is designated by the user.

At Step S42, if the determination at Step S41 is made that the number is designated, then the designated number of the execution cycles is set as a scheduling time range.

At Step S43, if the determination at Step S41 is made that the number is not designated, then a minimum number of the execution cycles in a case where the instruction sequence to be scheduled is executed with maximum execution efficiency is set as a scheduling time range. Thus, in a case where required execution efficiency is not designated, and circuit area and power consumption are required to be reduced while the maximum execution efficiency is achieved, the user does not need to designate the number of the execution cycles.

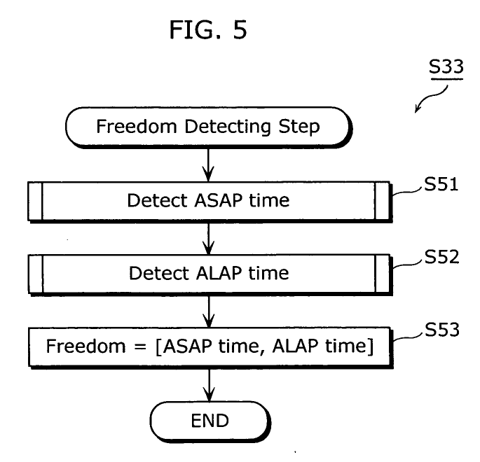

Next, the freedom detecting step (S33) is described with reference to FIG. 5.

FIG. 5 is a flowchart showing the freedom detecting step in detail.

At Step S51, when each instruction is placed within the scheduling time range, an earliest time in a placeable time period (hereinafter, referred to as “an as soon as possible” (ASAP) time) is calculated by sequentially adding latencies between instructions in order of parent nodes as priorities. Note that the latency represents a time period from when a parent node starts execution until a child note becomes ready for execution if the two instructions have interdependencies. A unit of the latency is ns (nanosecond), and in a case where two instructions have true interdependencies, the latency is equivalent to a time period required to execute a parent node. On the other hand, in a case where two instructions have inverse interdependencies or output interdependencies, the latency is equivalent to zero.

At Step S52, when each instruction is placed within the scheduling time range, a latest time in a placeable time period (hereinafter, referred to as “as late as possible” (ALAP) time) is calculated by sequentially subtracting latencies between instructions in order of child nodes as priorities.

At Step S53, a freedom of each instruction is calculated using the ASAP time calculated at Step S51 and the ALAP time calculated at Step S52. The freedom represents a time range from the ASAP time until the ALAP time, and the instruction can be placed within the range. Note that the ASAP time and the ALAP time are indicated by a placeable cycle and an offset counted from a start time of the placeable cycle.

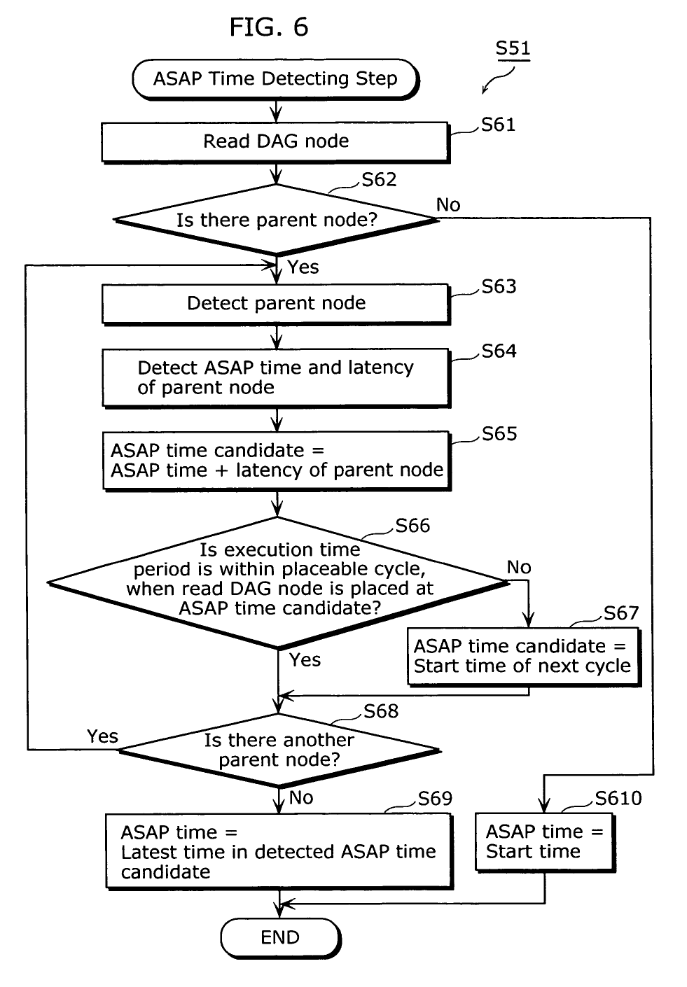

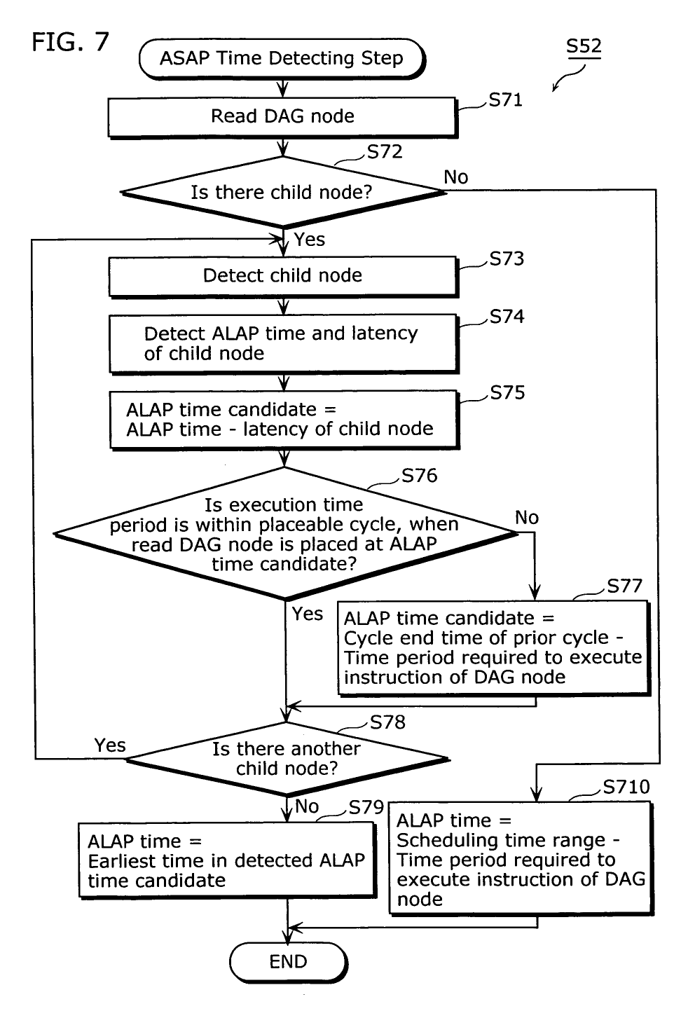

Here, the ASAP time detecting step and the ALAP time detecting step are described with reference to FIGS. 6 and 7.

FIG. 6 is flowchart showing the SAP time detecting step in more detail.

At Step S61, a DAG node generated by the DAG generation unit 15 is read.

At Step S62, a determination is made as to whether or not the DAG node read at Step S61 has a parent node.

At Step S63, if the determination at Step S62 is made that the DAG node has a parent node, then the parent node is detected.

At Step S64, an ASAP time and a latency of the parent node detected at Step S63 are calculated.

At Step S65, a ASAP time candidate is calculated from the ASAP time and the latency of the parent node calculated at Step S64.

If the DAG node read at Step S61 is placed at the ASAP time candidate calculated at Step S65, then at Step S66, a determination is made as to whether or not an execution time period of the DAG node read at Step S61 is within the placeable cycle.

At Step S67, if the determination at Step S66 is made that the execution time period of the DAG is not included within the placeable cycle, then the ASAP time candidate is changed to a start time of a cycle subsequent to the cycle having the ASAP time candidate calculated at Step S65.

At Step S68, a determination is made as to whether or not the DAG node read at Step S61 has still another parent node. If another parent node exists, the processing repeats steps from Step S63 to Step S67 for the node.

After calculating ASAP time candidates of all parent nodes at Steps S63 to S67, then at Step S69, the latest time in the detected ASAP time candidates is set as an ASAP time of the DAG node read at Step S61.

At Step S610, if the determination at Step S62 is made that there is no still parent node, then the start time is set as the ASAP time.

FIG. 7 is a flowchart showing the ALAP time detecting step in more detail.

At Step S71, a DAG node generated by the DAG generation unit 15 is read.

At Step S72, a determination is made as to whether the DAG node read at Step S71 has a child node.

At Step S73, if the determination at Step S72 is made that the DAG node has a child node, then the child node is detected.

At Step S74, an ALAP time and a latency of the child node detected at Step S73 are calculated.

At Step S75, an ALAP time candidate is calculated from the ALAP time and the latency of the child node calculated at Step S74.

If the DAG node read at Step S71 is placed at the ALAP time candidate calculated at Step S75, then at Step S76, a determination is made as to whether an execution time period of the DAG node read at Step S71 is within the placeable cycle.

At Step S77, if the determination at Step S76 is made that the execution time period of the DAG node is not included within the placeable cycle, then the ALAP time candidate is changed to a time which is calculated by subtracting a time period required to executing the instruction from a cycle end time in a cycle prior to the cycle having the ALAP time candidate calculated at Step S75.

At Step S78, a determination is made as to whether or not the DAG node read at Step S71 has another child node. If the determination at Step S78 is made that another child node exists, then the processing repeats the steps from Step S73 to Step S77 for the node.

After calculating the ALAP time candidates of all child nodes at Steps S73 to S77, then at Step S79, the earliest time in the detected ALAP time candidates is set as an ALAP time of the DAG node read at Step S71.

At Step S710, if the determination at Step S72 is made that there is no sill child node, then a time which is calculated by subtracting a time period required to executing the instruction from a cycle end time of a cycle that is the latest cycle in the scheduling time range is set as an ALAP time.

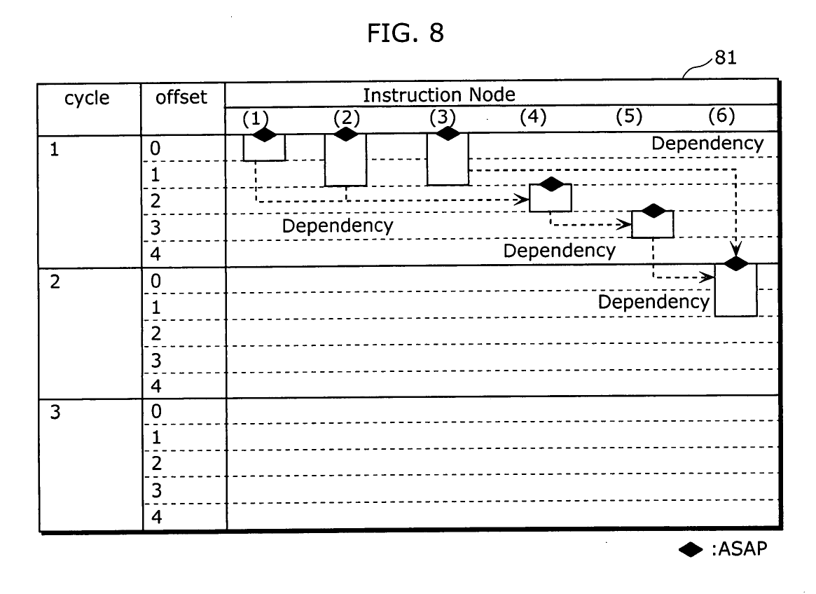

Next, FIGS. 8, 9 and 10 show examples in which ASAP times, ALAP times, and freedoms of the instruction sequence P2 shown in FIG. 2A are calculated. It is assumed that an execution time period required to execute each instruction is 2 ns for a multiplication instruction, 1 ns for an addition instruction, and 1 ns for a shift instruction, and all instructions have true interdependencies. It is also assumed that a time period of one cycle is 5 ns, and a scheduling time range is designated as three cycles.

FIG. 8 is an explanatory diagram showing the ASAP times of the instruction sequence P2 shown in FIG. 2A.

In FIG. 8, cycles 1 to 3 represent a scheduling time range, black rhombuses represent ASAP times of respective instructions, and bars extended from the black rhombuses represent latencies of respective instructions.

Based on the DAG shown in FIG. 2B, the instruction 1 (addition), the instruction 2 (multiplication), and the instruction 3 (multiplication) are placed at a start time of the first cycle, and each ASAP time is indicated by cycle=1 and offset=0.

Next, the instruction 4 (shift) depends on the instruction 1 (addition) and the instruction 2 (multiplication), so that parent nodes of the instruction 4 (shift) are the instruction 1 (addition) and the instruction 2 (multiplication). An ASAP time of the parent node instruction 1 (addition) is added with a latency, thereby obtaining a time of cycle=1 and offset=1. Furthermore, an ASAP time of the parent node instruction 2 (multiplication) is added with a latency to obtain a time of cycle=1 and offset=1. Therefore, an ASAP time candidate of the instruction 4 (shift) is the time of cycle=1 and offset=2. When the ASAP time candidate is added with an execution time period of the instruction 4 (shift), the execution time period is within the palceable cycle, so that an ASAP time of the instruction 4 (shift) becomes a time of cycle=1 and offset=2.

Next, the instruction 5 (addition) depends on the instruction 4 (shift), so that a parent node of the instruction 5 (addition) is the instruction 4 (shift). An ASAP time of the parent node instruction 4 (shift) is added with a latency, thereby obtaining a time of cycle=1 and offset=3. Therefore, an ASAP time candidate of the instruction 5 (addition) is the time of cycle=1 and offset=3. When the ASAP time candidate is added with an execution time period of the instruction 5 (addition), the execution time period is within the palceable cycle, so that an ASAP time of the instruction 5 (addition) is the time of cycle=1 and offset=3.

Next, the instruction 6 (multiplication) depends on the instruction 5 (addition) and the instruction 3 (multiplication), so that parent nodes of the instruction 6 (multiplication) are the instruction 5 (addition) and the instruction 3 (multiplication). An ASAP time of the parent node instruction 5 (addition) is added with a latency, thereby obtaining a time of cycle=1 and offset=4. Furthermore, an ASAP time of the parent node instruction 3 (multiplication) is added with a latency, thereby obtaining a time of cycle=1 and offset=2. Therefore, an ASAP time candidate of the instruction 6 (multiplication) is the time of cycle=1 and offset=4. However, when the ASAP time candidate is added with an execution time period of the instruction 6 (multiplication), the execution time period is not included within the palceable cycle, so that an ASAP time of the instruction 6 (multiplication) is a time of cycle=2 and offset=0.

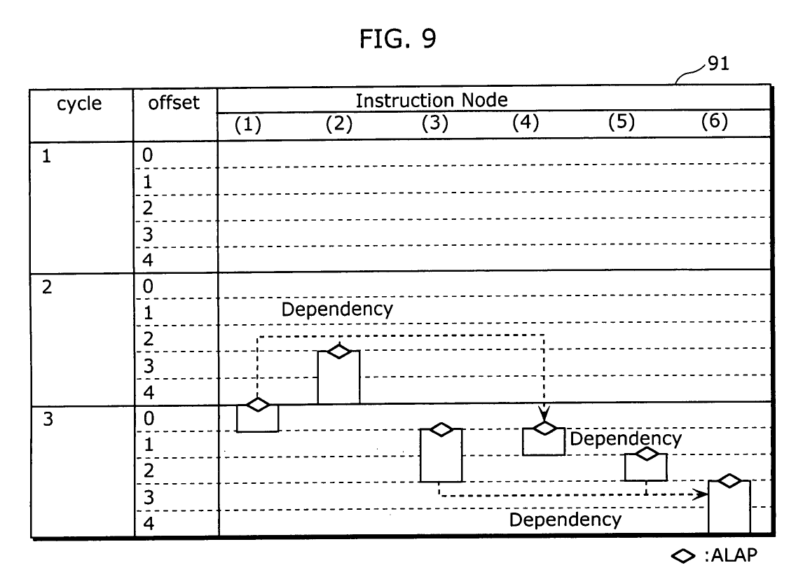

FIG. 9 is an explanatory diagram showing ALAP times of the instruction sequence P2 shown in FIG. 2A.

In FIG. 9, white rhombuses represent ALAP times of respective instructions.

Based on the DAG of the instruction sequence P2 as shown in FIG. 2B, the instruction 6 (multiplication) is placed to complete execution at a bottom of the scheduling time range, so that an ALAP time becomes a time of cycle=3 and offset=3.

Next, the instruction 5 (addition) is an instruction on which the instruction 6 (multiplication) depends, so that a child node of the instruction 5 (addition) is the instruction 6 (multiplication). A latency is subtracted from an ALAP time of the child node instruction 6 (multiplication), thereby obtaining a time of cycle=3 and offset=2. Therefore an ALAP time candidate of the instruction 5 (addition) is the time of cycle=3 and offset=2. When the ALAP time candidate is added with an execution time period of the instruction 5 (addition), the execution time period is within the palceable cycle, so that an ALAP time of the instruction 5 (addition) is the time of cycle=3 and offset=2.

Next, the instruction 4 (shift) is an instruction on which the instruction 5 (addition) depends, so that a child node of the instruction 4 (shift) is the instruction 5 (addition). A latency is subtracted from an ALAP time of the child node instruction 5 (addition), thereby obtaining a time of cycle=3 and offset=1. Therefore an ALAP time candidate of the instruction 4 (shift) is the time of cycle=3 and offset=1. When the ALAP time candidate is added with an execution time period of the instruction 4 (shift), the exectuion time period is within the palceable cycle, so that an ALAP time of the instruction 4 (shift) is the time of cycle=3 and offset=1.

Next, the instruction 3 (multiplication) is an instruction on which the instruction 6 (multiplication) depends, so that a child node of the instruction 3 (multiplication) is the instruction 6 (multiplication). A latency is subtracted from an ALAP time of the child node instruction 6 (multiplication), thereby obtaining a time of cycle=3 and offset=1. Therefore an ALAP time candidate of the instruction 3 (multiplication) is the time of cycle=3 and offset=1. When the ALAP time candidate is added with an execution time period of the instruction 3 (multiplication), the exectuion time period is within the palceable cycle, so that an ALAP time of the instruction 3 (multiplication) is the time of cycle=3 and offset=1.

Next, the instruction 2 (multiplication) is an instruction on which the instruction 4 (shift) depends, so that a child node of the instruction 2 (multiplication) is the instruction 4 (shift). A latency is subtracted from an ALAP time of the child node instruction 4 (shift), thereby obtaining a time of cycle=2 and offset=4. Therefore an ALAP time candidate of the instruction 2 (multiplication) is the time of cycle=2 and offset=4. However, when the ALAP time candidate is added with an execution time period of the instruction 2 (multiplication), the execution time period is not included within the placeable cycle, so that an ALAP time of the instruction 2 (multiplication) becomes a time of cycle=2 and offset=3.

Next, the instruction 1 (addition) is an instruction on which the instruction 4 (shift) depends, so that a child node of the instruction 1 (addition) is the instruction 4 (shift). A latency is subtracted from an ALAP time of the child node instruction 4 (shift), thereby obtaining a time of cycle=3 and offset=0. Therefore an ALAP time candidate of the instruction 1 (addition) is the time of cycle=3 and offset=0. When the ALAP time candidate is added with an execution time period of the instruction 1 (addition), the execution time period is within the palceable cycle, so that an ALAP time of the instruction 1 (addition) is the time of cycle=3 and offset=0.

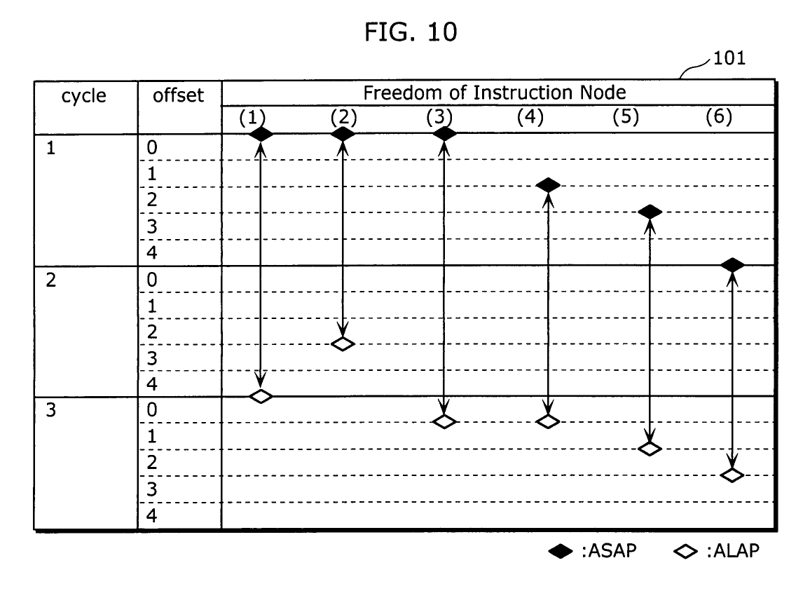

FIG. 10 is an explanatory diagram showing the freedoms in placement of the respective instructions included in the instruction sequence P2 shown in FIG. 2A.

A freedom is from an ASAP time in FIG. 8 to an ALAP time in FIG. 9, so that a freedom of the instruction 1 (addition) is from a time of cycle=1 and offset=0 to a time of cycle=3 and offset=0, a freedom of the instruction 2 (multiplication) is from a time of cycle=1 and offset=0 to a time of cycle=2 and offset=3, a freedom of the instruction 3 (multiplication) is from a time of cycle=1 and offset=0 to a time of cycle=3 and offset=1, a freedom of the instruction 4 (shift) is from a time of cycle=1 and offset=0 to a time of cycle=3 and offset=1, a freedom of the instruction 5 (addition) is from a time of cycle=1 and offset=3 to a time of cycle=3 and offset=2, and a freedom of the instruction 6 (multiplication) is from a time of cycle=2 and offset=0 to a time of cycle=3 and offset=3.

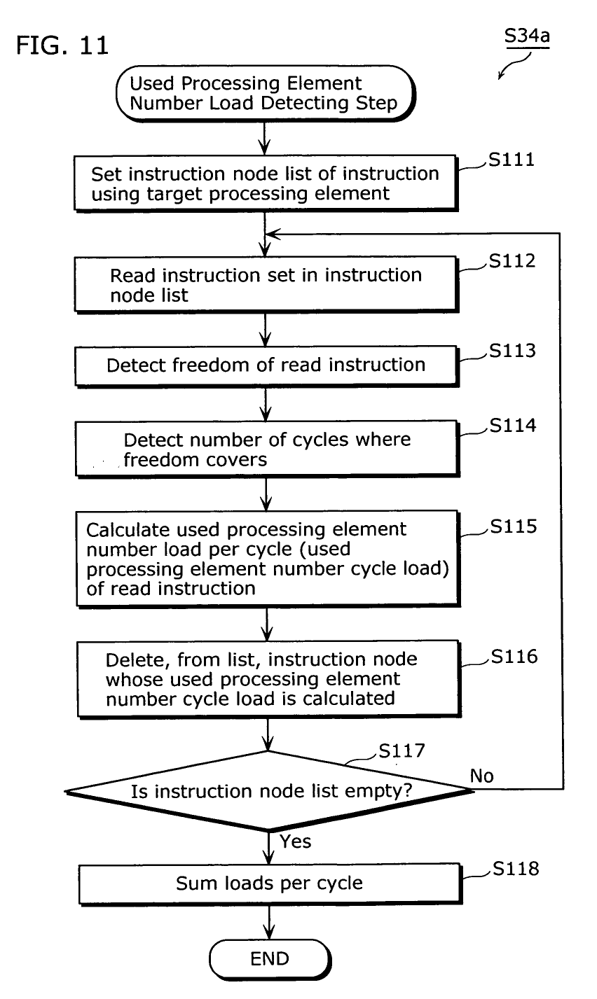

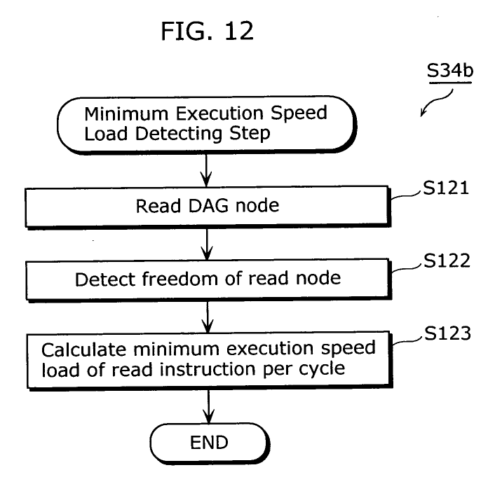

Next, the load detecting steps S34a and S34b are described in more detail with reference to FIGS. 11 and 12.

FIG. 11 is a flowchart showing the used processing element number load detecting step in more detail.

At Step S11, instructions using a processing element whose number load is to be calculated are set in an instruction node list.

At Step S112, an instruction in the instruction node list is read.

At Step S113, a freedom in the read instruction is detected.

At Step S114, the number of cycles where the freedom detected at Step S113 covers is detected. In other words, a total number of cycles where the read instruction has a possibility of being placed is calculated.

At Step S115, a used processing element number load of the read instruction for each cycle is calculated from the number of cycles detected at Step S114. It is assumed that a used processing element number cycle load of a load where a freedom does not cover is zero, while a used processing element number cycle load of a load where a freedom covers is calculated by the following equation 2;
Used processing element number cycle load=1/Number of cycles where freedom covers [Equation 2]

At Step S116, an instruction node whose used processing element number cycle load is calculated is deleted from the instruction node list.

At Step S117, a determination is made as to whether or not the instruction node list is empty. If the determination at Step S117 is made that the instruction node list is not empty, the processing loops back to Step S112, and on the other hand if the determination at Step S117 is made that the instruction node list is empty, the processing proceeds to Step S118.

At Step 118, the used processing element number cycle loads calculated at Step S115 are summed per cycle. It is assumed that the calculated load per cycle is a used processing element number load of the processing element.

FIG. 12 is a flowchart showing the minimum execution speed load detecting step in more detail.

At Step S121, a DAG node generated by the DAG generation unit 15 is read.

At Step S122, a freedom of the instruction read at Step S121 is detected.

At Step S123, a minimum execution speed load of the instruction read at Step S121 per cycle is calculated. Here, a minimum execution speed load of a cycle where a freedom does not cover is zero, while a minimum execution speed load of a cycle where a freedom cover is determined by the following equations 3 and 4;
Maximum executable time period=Maximum time period which is available for an execution time period, in a case where an instruction node is placed in a cycle whose minimum execution speed load is to be calculated [Equation 3]
Minimum execution speed load=1/Maximum executable time period [Equation 4]

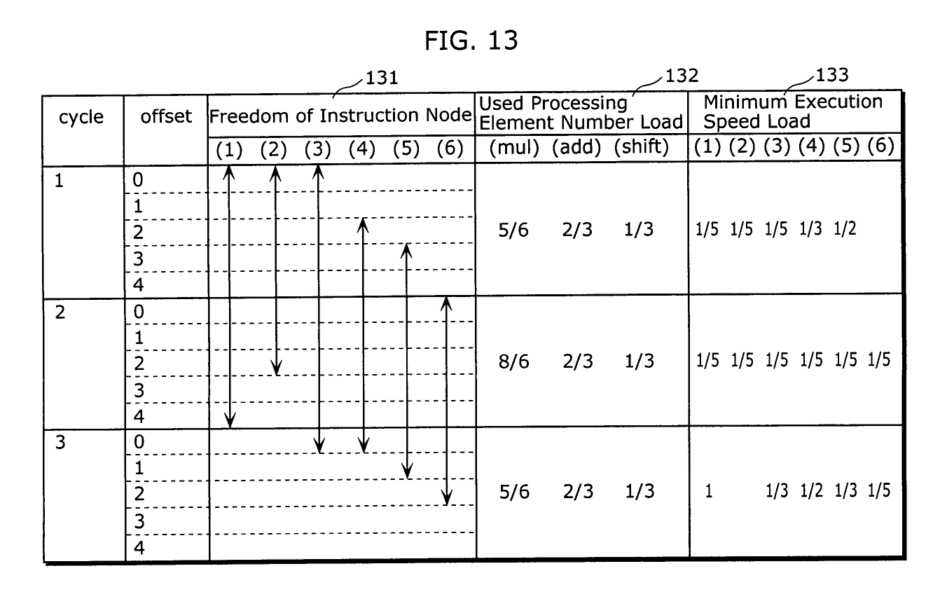

Next, a example in which used processing element number loads and minimum execution speed loads of the instruction sequence P2 shown in FIG. 2A is shown in FIG. 13.

FIG. 13 is a diagram showing a specific example of used processing element number loads and minimum execution speed loads which are calculated from the instruction sequence P2 shown in FIG. 2A.

In FIG. 13, freedoms 131 of instruction nodes are the freedoms of the instruction sequence P2 shown in FIG. 2A and are same as the results shown in FIG. 10.

Used processing element number loads 132 are the used processing element number loads of the instruction sequence P2 shown in FIG. 2A.

Here, used processing element number loads of a multiplier are described as examples.

Instructions using the multiplier are three instructions: the instruction 2 (multiplication), the instruction 3 (multiplication), and the instruction 6 (multiplication). Firstly, a used processing element number cycle load of the instruction 2 (multiplication) is calculated. Cycles where a freedom of the instruction 2 (multiplication) covers are the cycle 1 and the cycle 2. Thus, used processing element number cycle loads in the cycle 1 and the cycle 2 for the instruction 2 (multiplication) becomes 1/2. The freedom does not cover the cycle 3, so that a used processing element number cycle load of the cycle 3 is zero. In the same manner, used processing element number cycle loads of the instruction 3 (multiplication) and the instruction 6 (multiplication) are calculated to find that a used processing element number cycle load from the cycle 1 to the cycle 3 regarding the instruction 3 (multiplication) is 1/3, and that a used processing element number cycle load of the cycle 1 regarding the instruction 6 (multiplication) is zero, and a used processing element number cycle load of the cycle 2 and the cycle 3 regarding the instruction 6 is 1/2. Thus, the used processing element number cycle loads are summed per cycle, thereby obtaining a value 5/6 for the cycle 1, a value 8/6 for the cycle 2, and a value 5/6 for the cycle 3.

The minimum execution speed load 133 is a minimum execution speed load of the instruction sequence P2 shown in FIG. 2A.

Here, a minimum execution speed load of the cycle 3 regarding the instruction 4 (shift) is described as a example.

An executable time period in a case where the instruction 4 (shift) is placed in the cycle 3 becomes a maximum when the instruction 1 (addition) and the instruction 2 (multiplication) have been executed in cycles prior to the cycle 2 and eventually the instruction 4 (shift) can be executed from a start time of the cycle 3. Moreover, the instruction 5 (addition) and the instruction 6 (multiplication) also need to be placed in the cycle 3, so that the instruction 5 (addition) and the instruction 6 (multiplication) are scheduled from the bottom of the cycle 3, and eventually the instruction 5 (addition) is placed at a time of cycle=3 and offset=2 and the instruction 6 (multiplication) is placed at a time of cycle=3 and offset=3. In this case, a time range left for the instruction 4 (shift) becomes the executable time period. Thus, the instruction executable time period of the instruction 4 (shift) becomes 2. Therefore, a minimum execution speed load of the instruction 4 (shift) becomes 1/2.

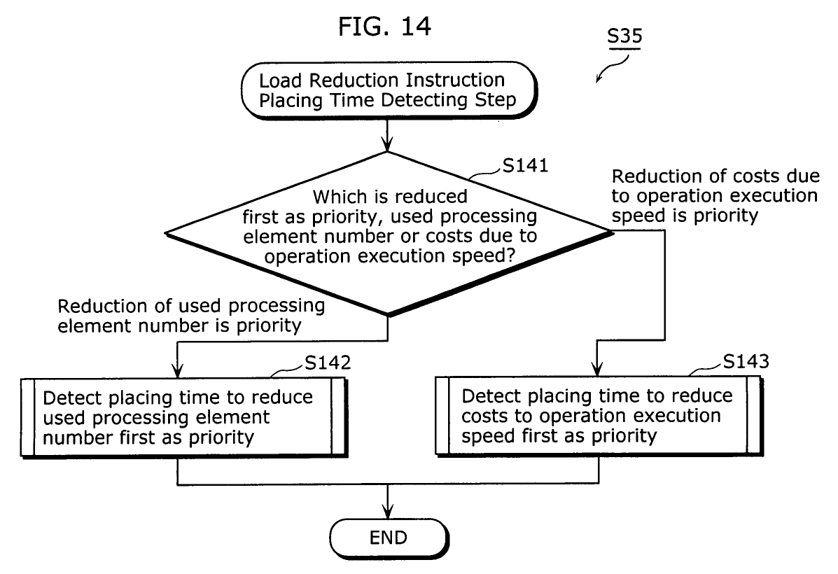

Next, the load reduction instruction placing time detection step S35 is described in more detail with reference to FIG. 14.

FIG. 14 is a flowchart showing the load reduction instruction placing time detecting step in more detail.

At Step S141, a determination is made as to which is to be reduced first as a priority, the used processing element number or the costs due to operation execution speed.

At Step S142, if the determination at Step S141 is made that the used processing element number is to be reduced first, then a placing time to reduce the used processing element number first is detected.

At Step S143, if the determination at Step S141 is made that the costs due to operation execution speed is to be reduced first, then a placing time to reduce the costs due to operation execution speed first is detected.

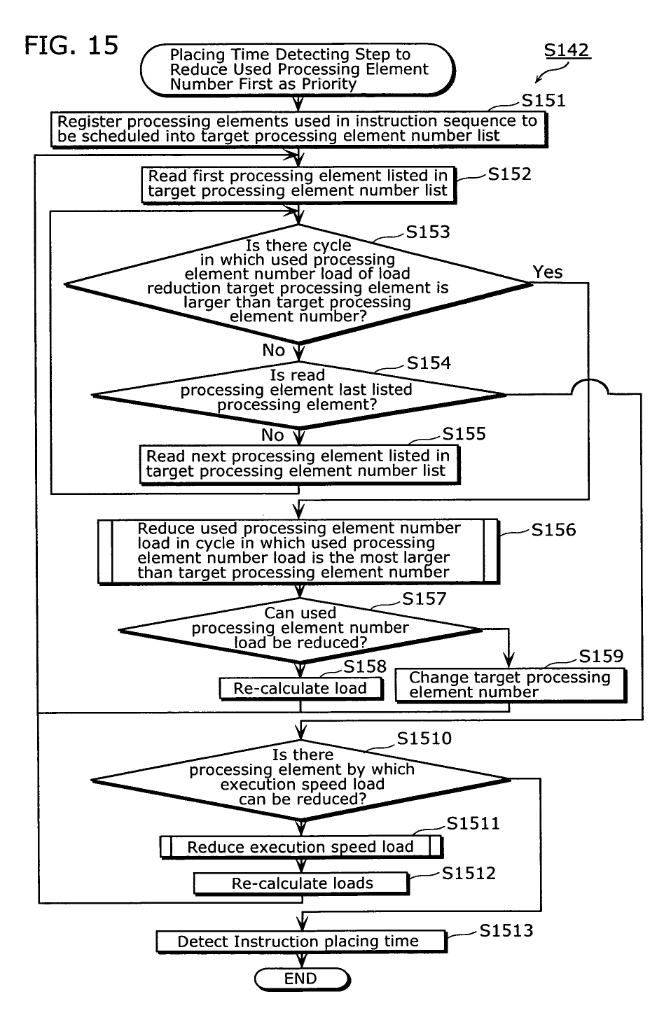

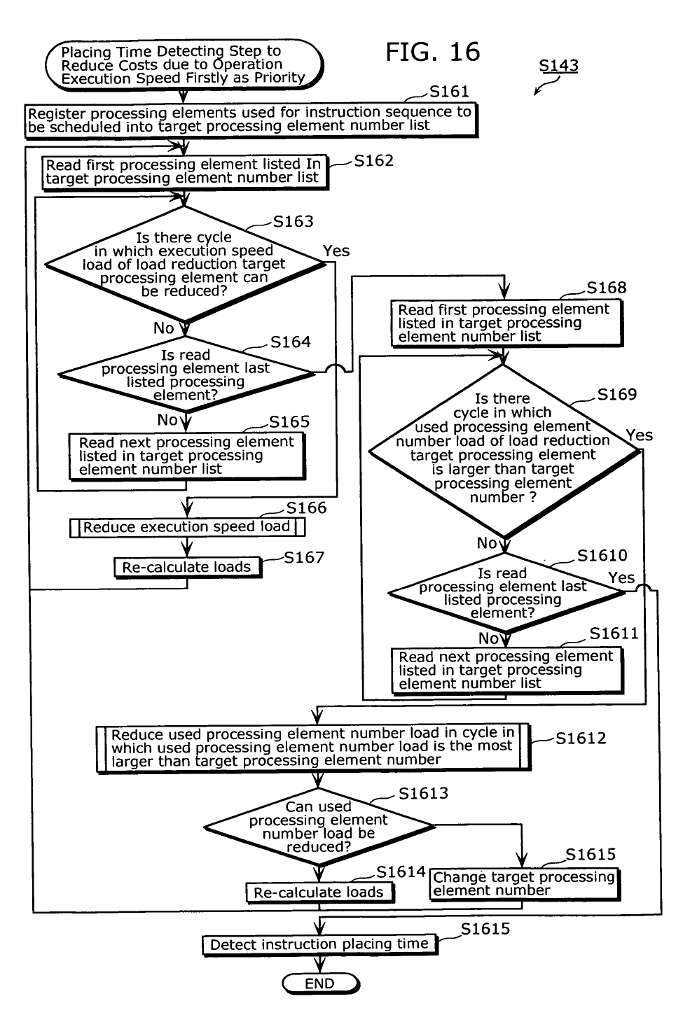

Here, the step for detecting the placing time to reduce the used processing element number first is described with reference to FIG. 15, and the step for detecting the placing time to reduce the costs due to operation execution speed first is described with reference to FIG. 16.

FIG. 15 is a flowchart showing the placing time detecting step to reduce the used processing element number first as a priority.

At Step S151, processing elements used in the instruction sequence to be scheduled are registered into a target processing element number list. It is assumed that, in the target processing element number list, processing elements by which used processing element recourses are reduced are registered in the list as priorities. Examples of such processing elements are a processing element with severe resources constrains (the number of processing element resources which can be executed within one cycle is small), a processing element with a small target processing element number, and the like.

At Step S152, the first processing element listed in the target processing element number list registered at Step S151 is read. The read processing element is assumed to be a load reduction target processing element.

At Step S153, a determination is made as to whether or not there is a cycle in which a used processing element number load of the load reduction object processing element is larger than the target processing element number.

At Step S154, if the determination at Step S153 is made that there is no such a cycle, then a determination is made as to whether or not the processing element read at Step S152 is a last processing element listed in the target processing element number list.

At Step 155, if the determination at Step S154 is made that the processing element is not the last listed element, then a next listed element is read.

At Step S156, if the determination at Step S153 is made that such a cycle exists, then a freedom of each instruction node is changed in order to reduce a used processing element number load in a cycle in which a used processing element number load of the processing element read at Step S152 is the most larger than the target processing element number.

At Step S157, a determination is made as to whether or not the used processing element number load can be reduced at Step S156. At Step 158, if the determination at Step S157 is made that the reduction is possible, then the used processing element number load is re-calculated since the freedom of each instruction node can be changed at Step S156. After the re-calculation, the processing loops back to Step S152.

At Step 159, if the determination at Step S157 is made that the reduction is not possible, then a value of the used processing element number load is further set to as the target processing element number. After the setting, the processing loops back to Step S152.

At Step 1510, if the determination at Step S153 is made that there is no such a cycle, then a determination is made as to whether or not there is a processing element by which an execution speed load can be reduced.

At Step S1511, if the determination at Step S1510 is made that there is a processing element by which an execution speed load can be reduced, then an execution speed load is reduced for a processing element whose power consumption is lager than any other processing elements by which an execution speed load can be reduced.

At Step S1512, the loads are re-calculated after a freedom of each instruction is changed at Step S1511. After the re-calculation, the processing loops back to Step 152.

At Step S1513, if the determination at Step S1510 is made that there is no processing element by which an execution speed load can be reduced, then an instruction placing time is calculated based on the freedom of each instruction in order to minimize the execution speed load.

FIG. 16 is a flowchart showing a placing time detecting step to reduce the costs due to operation execution speed first as a priority.

At Step S161, processing elements used for the instruction sequence to be scheduled are registered into a target processing element number list. It is assumed that, in the target processing element number list, processing elements whose used processing element recourses are to be reduced are registered as priorities. Examples of such processing elements are a processing element with server resource constrains (with the small number of processing element resources which are available in one cycle), a processing element with a small target processing element number, and the like.

At Step S162, the first processing element listed in the target processing element number list registered at Step S161 is read. The read processing element is regarded as a load reduction target processing element.

At Step S163, a determination is made as to whether or not there is an instruction by which an execution speed load of the processing element read at Step S162 can be reduced.

At Step S164, if the determination at Step S163 is made that there is no such instruction by which an execution speed load of the processing element read at Step S162 can be reduced, then a determination is made as to whether or not the processing element read at Step S162 is a last processing element listed in the target processing element number list.

At Step 165, if the determination at Step S164 is made that the processing element is not the last listed processing element, then a next listed element is read.

At Step S166, if the determination at Step S163 is made that there is such an instruction by which an execution speed load of the processing element can be reduced, then the execution speed load is reduced.

At Step 167, since a freedom of each instruction node is changed at Step S166, the loads are re-calculated. After the re-calculation, the processing loops back to Step S162.

At Step 168, if the determination at Step S164 is made that the processing element is the last listed processing element, then the first processing element listed in the target processing element number list is read.

At Step S169, a determination is made as to whether or not there is a cycle in which a used processing element number load of the load reduction target processing element is larger than the target processing element number.

At Step S1610, if the determination at Step S169 is made that there is no such a cycle in which a used processing element number load of the load reduction target processing element is larger than the target processing element number, then a determination is made as to whether or not the processing element read at Step S168 is a last processing element listed in the target processing element number list.

At Step 1611, if the determination at Step S1610 is made that the processing element is not a last listed processing element, then a next listed processing element is read.

At Step S1612, if the determination at Step S169 is made that there is such a cycle in which a used processing element number load of the load reduction target processing element is larger than the target processing element number, then a freedom of each instruction node is changed in order to reduce a used processing element number load in a cycle in which a used processing element number load of the processing element read at Step S168 is the most larger than the target processing element number.

At Step S1613, a determination is made as to whether or not the used processing element number load can be reduced at Step S1612.

At Step 1614, if the determination at Step S1613 is made that the reduction is possible, since the freedom of each instruction node is changed at Step S1612, the loads are re-calculated. After the re-calculation, the processing loops back to Step S162.

At Step 1615, if the determination at Step S1613 is made that the reduction is not possible, then a value of the used processing element number load is further set to as the target processing element number. After the setting, the processing loops back to Step S162.

At Step 1616, if the determination at Step S1610 is made that the processing element is the last listed processing element, then an instruction placing time is calculated by using the freedom of each instruction in order to minimize the execution speed load.

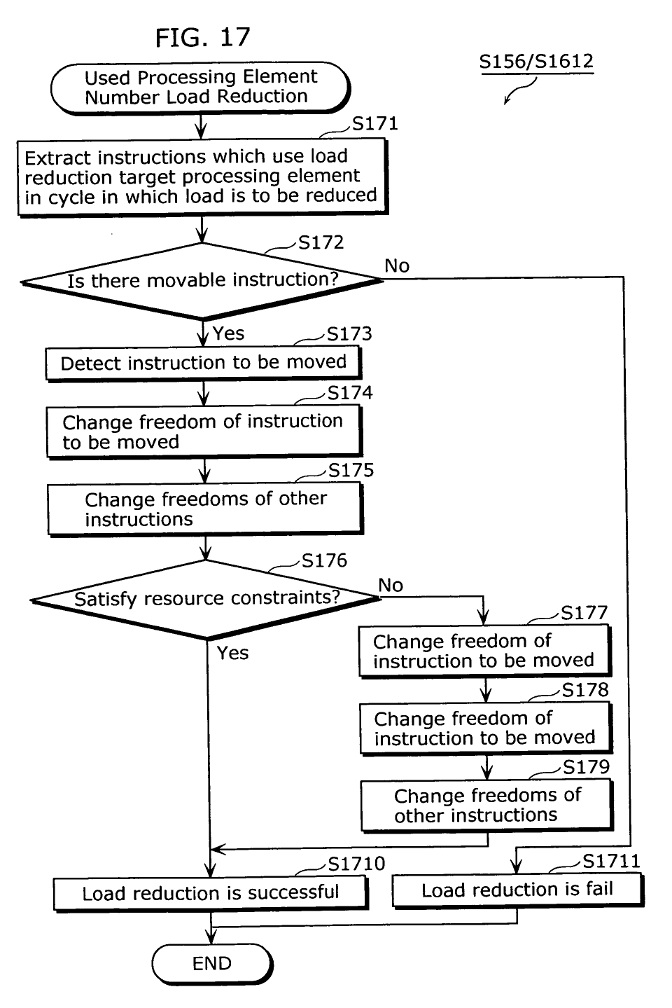

Next, reduction of the used processing element number load at Steps S156 and S1612 are described with reference to FIG. 17.

FIG. 17 is a flowchart showing the used processing element load reducing step in more detail.

At Step S171, instruction nodes using the load reduction target processing element in a cycle in which a used processing element load is reduced (cycle in which a used processing element number load is the most larger than the target processing element number) are extracted.

At Step S172, a determination is made as to where or not there is an movable instruction (instruction whose ASAP time and ALAP time exist in different cycles) among the instruction nodes extracted at Step S171.

At Step 173, if the determination at Step S172 is made that there is such a movable instruction node, then the instruction is selected as an instruction to be moved. Here, if there is an instruction which has a possibility of being placed in a cycle prior to the load reduction target cycle among the instruction nodes extracted at Step S171 (if a cycle having the ASAP time<the load reduction target cycle), to be set as the instruction to be moved, an instruction is detected in the following order:

(Priority 1) Instruction whose height is the highest;

(Priority 2) Instruction with a maximum number of child nodes;

(Priority 3) Instruction whose depth is the narrowest;

(Priority 4) Instruction with a minimum number of parent nodes; and

(Priority 5) Instruction with a minimum DAG node ID,

wherein the height means a position of the node in the node hierarchy, and depth means an order of the node in the node hierarchy.

If there is no instruction which has a possibility of being placed in a cycle prior to the load reduction target cycle (if a cycle having the ASAP time=the load reduction target cycle), to be set as the instruction to be moved, an instruction is detected in the following order:

(Priority 1) Instruction whose height is the lowest;

(Priority 2) Instruction with a minimum number of child nodes;

(Priority 3) Instruction whose depth is the deepest;

(Priority 4) Instruction with a maximum number of parent nodes; and

(Priority 5) Instruction with a maximum DAG node ID,

wherein the height means a position of the node in the node hierarchy, and depth means an order of the node in the node hierarchy.

At Step S174, a freedom of the instruction to be moved which is detected at Step S173 is changed. Here, if the instruction to be moved has a possibility of being placed in a cycle prior to the load reduction target cycle (if a cycle having the ASAP time<the load reduction target cycle), the ALAP time of the instruction to be moved is changed to a time which is obtained by subtracting a time period required to execute the instruction node from a cycle end time of a cycle immediately prior to the load reduction target cycle. On the other hand, if the instruction to be moved does not have a possibility of being placed in a cycle prior to the load reduction target cycle (if a cycle having the ASAP time >=the load reduction target cycle), the ASAP time of the instruction to be moved is changed to a start time of a cycle subsequent to the load reduction target cycle.

At Step S175, since the freedom of the instruction to be moved is changed at Step S174, freedoms of all instruction nodes are changed.

At Step S176, a determination is made as to whether or not the freedoms changed at S175 can satisfy the resource restraints.

At Step S177, if the determination at Step S176 is made that the resource restraints cannot be satisfied, then the freedoms changed at Steps S174 and S175 are re-changed to the original freedoms.

At Step S178, the freedoms changed at Steps S174 and S175 are further changed. Here, if the instruction to be moved has a possibility of being placed in a cycle prior to the load reduction target cycle (if a cycle having the ASAP time<the load reduction target cycle), the ASAP time of the instruction to be moved is changed to a start time of a cycle subsequent to the load reduction target cycle. On the other hand, if the instruction to be moved does not have a possibility of being placed in a cycle prior to the load reduction target cycle (if a cycle having the ASAP time >=the load reduction target cycle), the ALAP time of the instruction to be moved is changed to a time which is obtained by subtracting a time period required to execute the instruction node from a cycle end time of the load reduction target cycle.

At Step S179, since the freedom of the instruction to be moved is further changed at Step S178, freedoms of all instruction nodes are changed.

At Step S1710, since the freedoms are changed at Steps S174 and S175 or at Steps S178 and S179, the load reduction is considered as successful.

At Step S1711, since the freedoms cannot be changed, the load reduction is considered as fail.

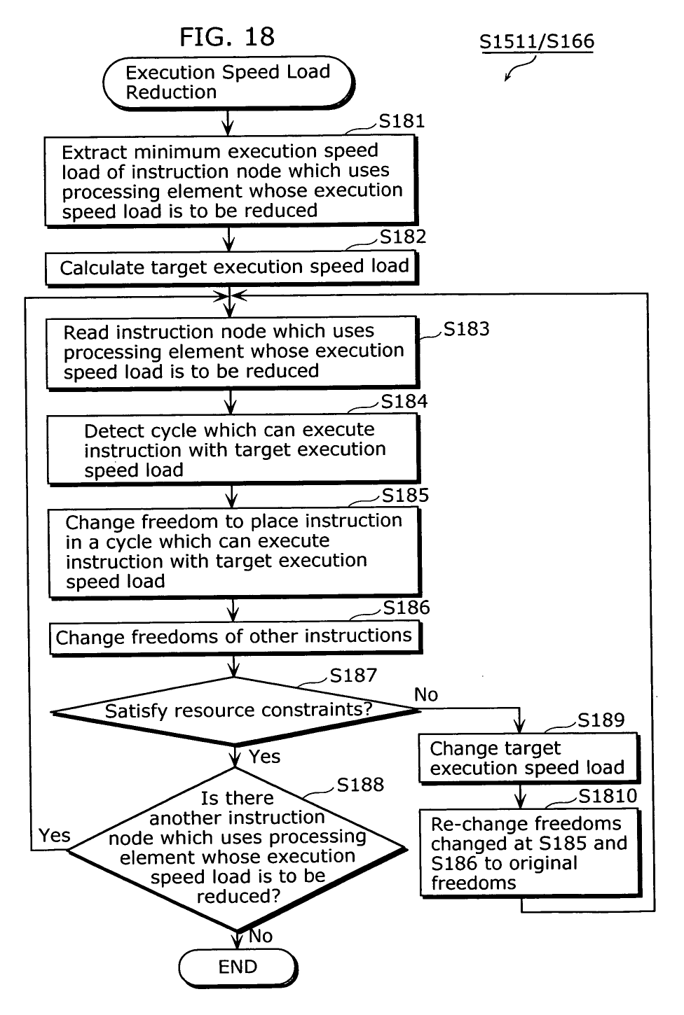

Next, reduction of the execution speed load at Steps S1511 and S166 is described with reference to FIG. 18.

FIG. 18 is a flowchart showing the execution speed load reducing step in more detail.

At Step S181, a minimum execution speed load of an instruction node using a processing element whose execution speed load is to be reduced is extracted.

At Step S182, a target execution speed load is calculated. It is assumed that the target execution speed load is equivalent to a minimum execution speed load having a maximum value among respective minimum execution speed loads of instruction nodes using a processing element whose execution speed load is to be reduced. Thereby, instructions for executing the same operation can share the same processing element, and at the same time the instructions can use a low-cost processing element.

In a case where a plurality of instructions using the same type processing elements are placed in different cycles, it is desirable that those instructions share one processing element, but if respective execution time periods of those instructions are different, those instructions should use different processing elements and eventually cannot share the same processing element. Therefore, in a case where, even if a certain instruction can use a low-cost processing element for executing the instruction at a low speed, another instruction should use a high-cost processing element for executing the another instruction at a high speed, it is necessary to use the high-cost processing element for high-speed execution in order to share the same processing element by these instructions. Thus, At Step S182, from the beginning, instructions for executing the same operation should share the same processing element, and a load of a processing element having a speed enough to execute any instructions is calculated as a target execution speed load For example, if for a certain instruction (assumed to be the instruction 1), a minimum execution speed load in the cycle 1 is 1/3, a minimum execution speed load in the cycle 2 is 1/4, and if for another instruction using the same processing element (assumed to be the instruction 2), a minimum execution speed load in the cycle 1 is 1/5, a minimum execution speed load in the cycle 2 is 1/3, then minimum values of the minimum execution speed loads of these instructions are 1/4 for the instruction 1 and 1/5 for the instruction 2. Therefore, the target execution speed load is the largest value among these minimum values, namely 1/4.

Moreover, if for a certain instruction (assumed to be the instruction 3), a minimum execution speed load in the cycle 1 is 1/5, a minimum execution speed load in the cycle 2 is 1/4, and if for another instruction using the same processing element (assumed to be the instruction 4), a minimum execution speed load in the cycle 1 is 1/5, a minimum execution speed load in the cycle 2 is 1/3, then minimum values of the minimum execution speed loads of these instructions are 1/5 for both the instruction 3 and the instruction 4.

Therefore, the target execution speed load becomes 1/5, but both the instruction 3 and the instruction 4 can be placed only in the cycle 1 with the target execution speed. In such a case where, for the instructions using the same processing element, each instruction can be placed only in one cycle with the target execution speed and such a cycle is the same cycle for both instructions, then the target execution speed load is changed to a value which is obtained by indicating the target execution speed load as a fraction and adding 1 to the denominator. Therefore, in a case of the above example (the instruction 3 and the instruction 4), the target execution speed load becomes 1/4.

At Step S183, an instruction node using the processing element whose execution speed load is to be reduced is read.

At Step S184, a cycle in which the instruction can be executed with the target execution speed load is detected. Here, the cycle in which the instruction can be executed with the target execution speed load is a cycle in which a minimum execution speed load is smaller than the target execution speed load. There may be a plurality of cycles in which one instruction can be executed with the target execution speed load. In the example of the instruction 1 and the instruction 2 at Step S182, for the instruction 1 the cycle is the cycle 2, and for the instruction 2 the cycle is the cycle 1. In the example of the instruction 3 and the instruction 4, for the instruction 3 the cycle is the cycles 1 and 2, and for the instruction 4 the cycle is the cycle 2.

At Step S185, a freedom of the instruction is changed to place the instruction node in the cycle detected at Step S184.

At Step S186, since the freedom of the instruction is changed, freedoms of other instructions are changed.

At Step S187, after changing the freedoms, a determination is made as to whether or not the change can satisfy the resource constraints.

At Step S188, if the determination at Step S187 is made that the resource constraints can be satisfied, then a determination is made as to whether or not there is another instruction node using the processing element whose execution speed load is to be reduced. If the determination at Step S188 is made that there is such another instruction node, the processing repeats the Steps S183 to S188 for all instruction nodes using the processing element whose execution speed load is to be reduced. If all instruction nodes using the processing element whose execution speed load is to be reduced can satisfy the resource constraints, the processing completes.

At Step S189, if the determination at Step S187 is made that the resource constraints cannot be satisfied, the target execution speed load is changed. It is assumed that the changed target instruction speed load is equivalent to a value which is obtained by indicating the target instruction speed load as a fraction and adding 1 to the denominator.

At Step S1810, the freedoms changed at Steps S184 and S185 are re-changed to the original freedoms. After re-changing the freedoms to the original freedoms, the freedoms are further changed based on the target execution speed load changed at Step S189.

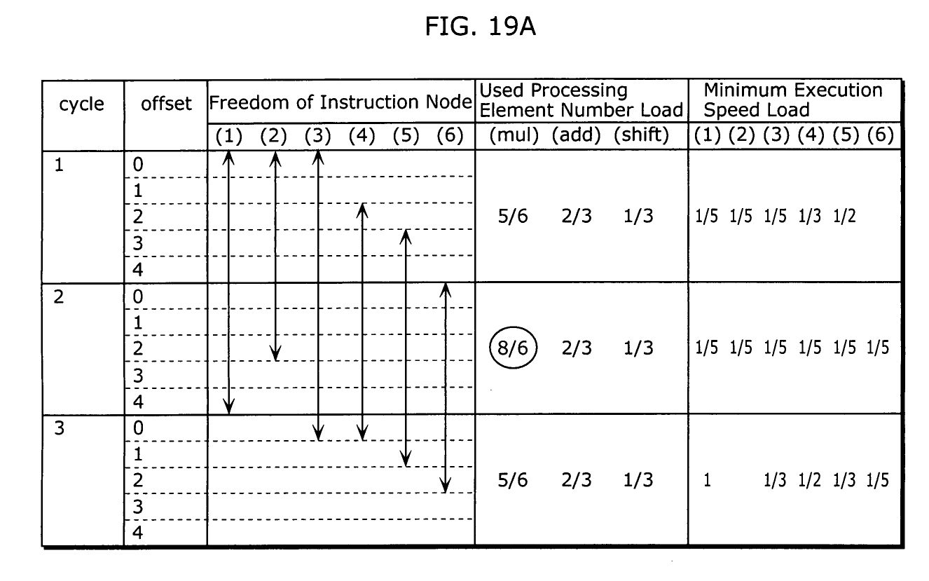

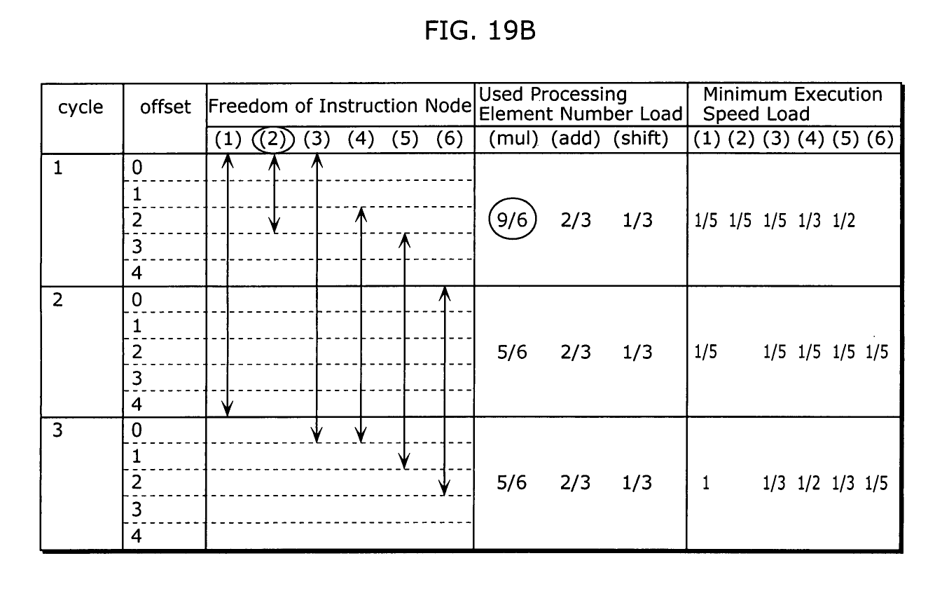

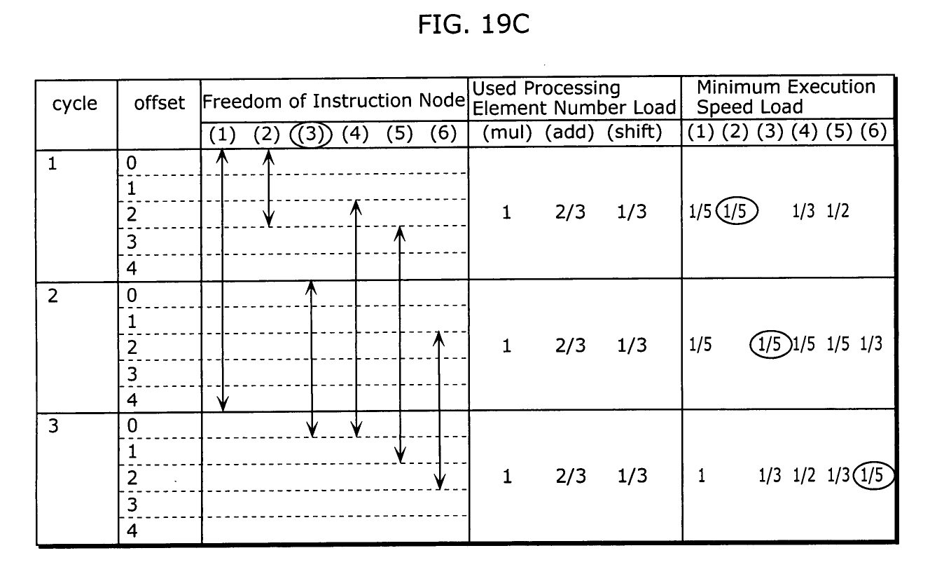

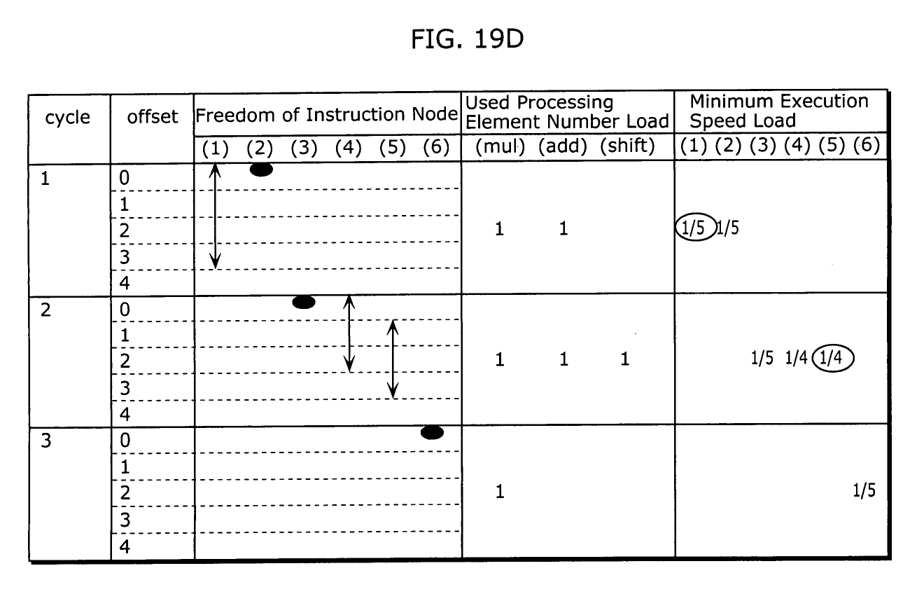

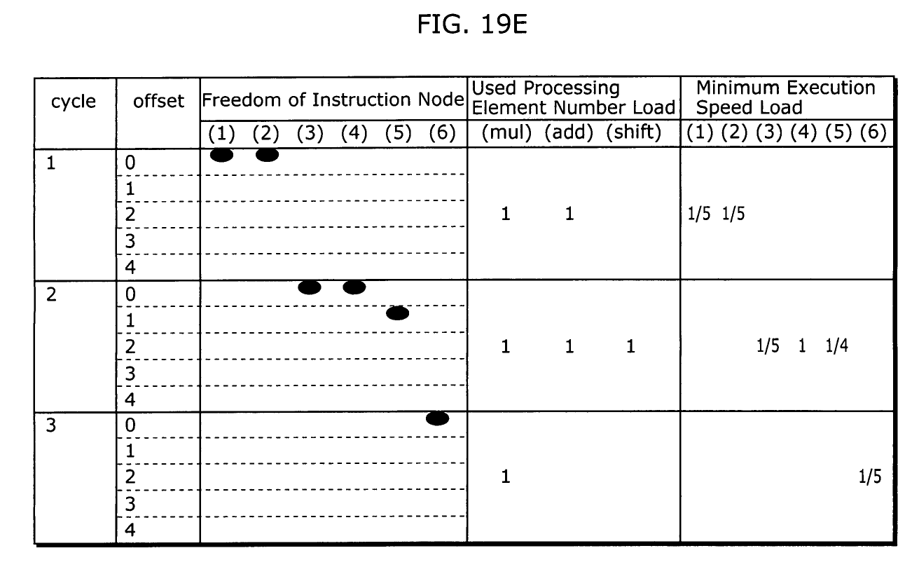

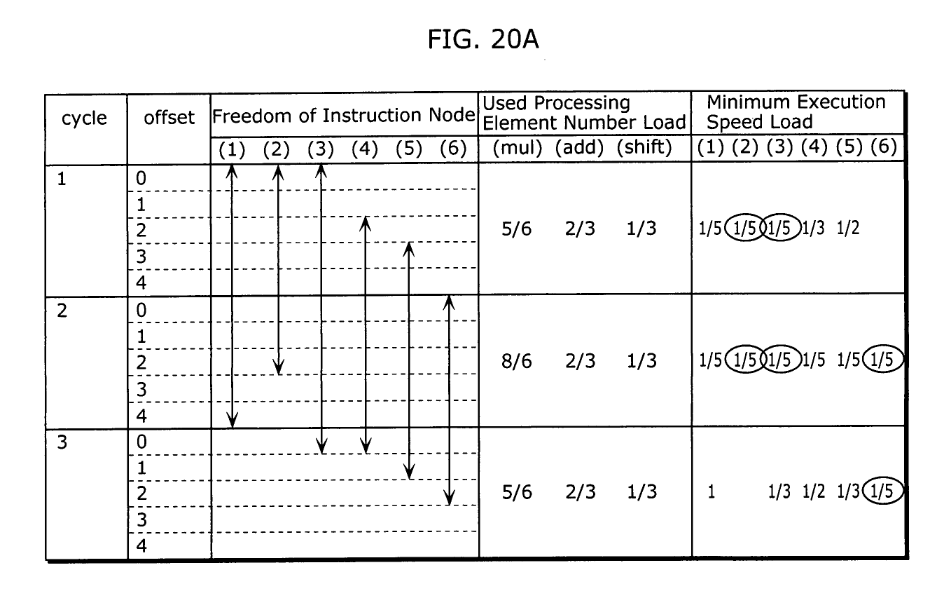

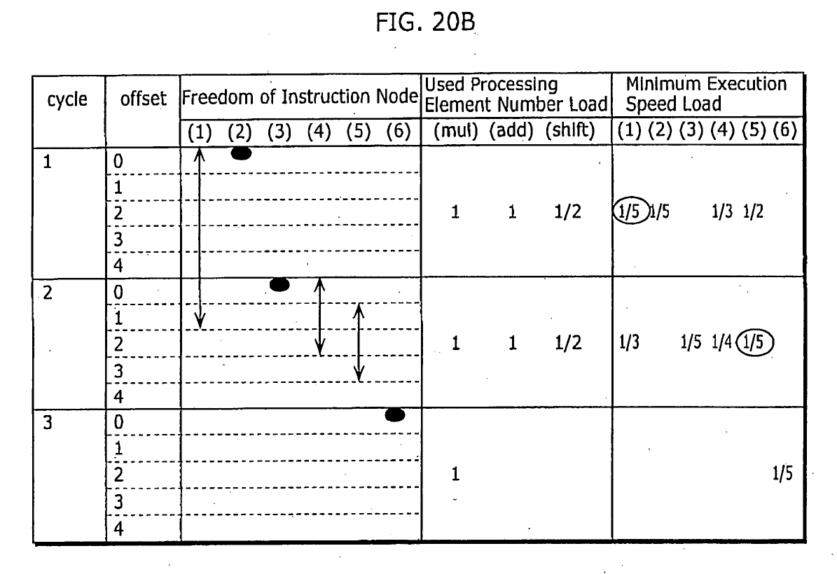

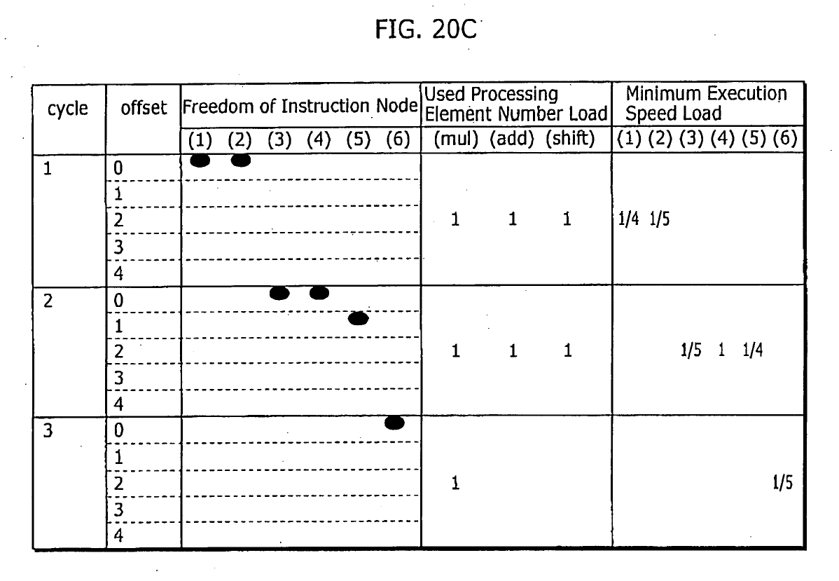

Next, processing for detecting a load reduction instruction placing time using the used processing element number load (S132) and the minimum execution speed load (S133) calculated from the instruction sequence P2 shown in FIG. 2A is described, with reference to FIGS. 19A to 19E and 20A to 20C.

FIGS. 19A to 19E are diagrams showing a specific example of processing for detecting a load reduction instruction placing time, in a case where the used processing element number is reduced first as a priority. It is assumed that the processing is performed for the multiplier, the adder, and the shifter sequentially in an order of priority to reduce the used processing element number and the costs due to operation execution speed.

FIG. 19A is a diagram showing freedoms and processing element number loads of the instruction sequence P2 shown in FIG. 2A, and the diagram is the same as the diagram of FIG. 13.

Firstly, a target processing element number of each processing element is calculated. The following are an example of the target processing element number of each processing element. Instructions using the multiplier are three instructions which are the instruction 2 (multiplication), the instruction 3 (multiplication), and instruction 6 (multiplication), and a scheduling time rage is 3, so that a target processing element number of the multiplier is calculated by the equation 1 to obtain
ceil (3/3)=1.

In the same manner, target processing element numbers of the adder and the shifter are calculated so that a target processing element number of the adder is 1, and a target processing element number of the shifter is 1.

Next, regarding the used processing element number load of each processing element, it is understood that, among the multipliers designated to firstly reduce used processing element and costs due to operation execution speed, a used processing element number load of the multiplier in the cycle 2 is larger than the target used processing element.

Therefore, from the instruction 2 (multiplication), the instruction 3 (multiplication), and the instruction 6 (multiplication), each using a multiplier which has a possibility of being placed in the cycle 2, an instruction to be moved is selected and then a freedom of the selected instruction is changed in order to set a used processing element number of the multiplier in the cycle 2 to be less than the target used operating unit number. Here, according to the order of priority at the above Step S173, the instruction to be moved becomes the instruction 2 (multiplication) which is the narrowest in depth and the highest in height.

FIG. 19B is a result when the instruction 2 (multiplication) to be moved is moved within the freedom in order to set the used processing element number of the multiplier in the cycle 2 to be less than the target used processing element number. As a result, the freedom of the instruction 2 (multiplication) is further set to be placed in the cycle 1. Thereby, the used processing element number load of the multiplier becomes 9/6 in the cycle 1, 5/6 in the cycle 2, and 5/6 in the cycle 3, so that it is understood that the used processing element number load of the cycle 1 is larger than the target used processing element number. Therefore, by selecting an instruction to be moved from the instruction 2 (multiplication) and the instruction 3 (multiplication) each using a multiplier which has a possibility of being placed in the cycle 1, and then changing a freedom of the selected instruction, the used processing element number of the multiplier in the cycle 1 is set to be less than the target used operating unit number. Here, according to the order of priority at the above Step S173, the instruction to be moved becomes the instruction 3 (multiplication) which has a plurality of placeable cycles (a cycle having the ASAP time is different from a cycle having the ALAP time).

FIG. 19C is a result when the instruction 3 (multiplication) to be moved is moved within the freedom in order to set a used processing element number of the multiplier in the cycle 1 to be less than the target used processing element number. As a result, the freedom of the instruction 3 (multiplication) is further set to be placed in a cycle subsequent to the cycle 2. Thereby, the used processing element number load of the multiplier is 1 in the cycles 1, 2, and 3, so that it is understood that the used processing element number load in each cycle is less than the target used processing element number. Furthermore, used processing element number loads of other processing elements except the multiplier is also less than the target used processing element number. Thus, all used processing element number loads become less than the target used processing element number, so that a placing time is then calculated within the freedom in order to minimize the costs due to operation execution speed. A minimum execution speed load of the multiplier designated to reduce firstly the used processing element number and the costs due to operation execution speed is 1/5 for the instruction 2 (multiplication), the instruction 3 (multiplication), and the instruction 6 (multiplication). Therefore, the target operation speed load becomes 1/5. Thus, placing times of the instruction 2 (multiplication), the instruction 3 (multiplication), and the instruction 6 (multiplication) are detected within the freedoms in order to set respective execution speed loads to as 1/5.

FIG. 19D is a result of detecting the placing times within the freedoms in order to set respective execution speed loads of the instruction 2 (multiplication), the instruction 3 (multiplication), and the instruction 6 (multiplication) to as 1/5. Black dots in FIG. 19D represent the placing times. Since the placing times of the instruction 2 (multiplication), the instruction 3 (multiplication), and the instruction 6 (multiplication) are detected, freedoms of instructions using other processing elements are influenced by these placing times. As a result of further calculating the processing element number load, the used processing element number load becomes less than the target processing element number, so that a placing time of the adder designated to reduce the used processing element number and the costs due to operation execution speed next to the multiplier is detected within a freedom in order to minimize the costs due to operation execution speed. A minimum execution speed load of the adder is 1/5 for the instruction 1 (addition) and 1/4 for the instruction 5 (addition). Therefore, the target operation speed load becomes 1/4. Thus, placing times of the instruction 1 (addition) and the instruction 5 (addition) are detected within the freedoms in order to set the execution speed load to as 1/4.

FIG. 19E is a result of detecting placing time within freedoms in order to set respective execution speed load of the instruction 1 (addition) and the instruction 5 (addition) to as 1/4. Black dots in FIG. 19E represent the placing times. Since the placing times of the instruction 1 (addition) and the instruction 5 (addition) are detected, freedoms of instructions using other processing elements are influenced by these placing times. As a result, a placing time of the instruction 3 (multiplication) is determined, so that placing times of all instructions are determined.

FIGS. 20A to 20C are diagrams showing a specific example of processing for detecting a load reduction instruction placing time, in a case where the costs due to operation execution speed is reduced as a priority. It is assumed as described above that the processing is performed for the multiplier, the adder, and the shifter sequentially in an order of priority to reduce the used processing element number and the costs due to operation execution speed.

FIG. 20A is a diagram showing freedoms and processing element number loads of the instruction sequence P2 shown in FIG. 2A, and the diagram is the same as the diagram of FIG. 13.

Firstly, a minimum execution speed load of the multiplier designated to firstly reduce the used processing element number and the costs due to operation execution speed is used. Minimum execution speed loads of the adder are 1/5 for the instruction 2 (multiplication), the instruction 3 (multiplication), and instruction 6 (multiplication), so that a target execution speed load becomes 1/5. Therefore, placing times of the instruction 2 (multiplication), the instruction 3 (multiplication), and instruction 6 (multiplication) are detected within freedoms in order to set respective execution speed loads to as 1/5.

FIG. 20B is a result of detecting the placing times within the freedoms in order to set respective execution speed loads of the instruction 2 (multiplication), the instruction 3 (multiplication), and the instruction 6 (multiplication). Black dots in FIG. 20B represent the placing times. Since the placing times of the instruction 2 (multiplication), the instruction 3 (multiplication), and the instruction 6 (multiplication) are detected, freedoms of instructions using other processing elements are influenced by these placing times, so that the loads are further detected. By using the result, placing times of the adder designated to reduce the used processing element number and the costs due to operation execution speed next to the multiplier are detected within the freedoms in order to minimize the costs due to operation execution speed. Minimum execution speed loads of the adder are 1/5 for the instruction 1 (addition) and the instruction 5 (addition). Therefore, the target execution speed load becomes 1/5. Thus, placing times of the instruction 1 (addition) and the instruction 5 (addition) are detected within the freedoms in order to set respective execution speed loads to as 1/5. However, it is not possible to detect a placing time to set the execution speed loads of both the instruction 1 (addition) and the instruction 5 (addition) to as 1/5, so that the target execution speed load is changed to 1/4 which is obtained by adding 1 with a denominator of the current target processing element number load, and placing times of the instruction 1 (addition) and the instruction 5 (addition) are further detected within the freedoms in order to set respective execution speed loads to as 1/4.

FIG. 20C is a result of detecting placing times within freedoms in order to set respective execution speed loads of the instruction 1 (addition) and the instruction 5 (addition) to as 1/4. Black dots in FIG. 20B represent the placing times. Since the placing times of the instruction 1 (addition) and the instruction 5 (addition are detected, freedoms of instructions using other processing elements are influenced by these placing times. As a result, a placing time of the instruction 3 (multiplication) is determined, so that placing times of all instructions are determined.

Next, results of the scheduling of the instruction sequence P2 shown in FIG. 2A in a case where the used processing element number is reduced as a priority, and in a case where the costs due to operation execution speed is reduced as a priority, are described with reference to FIGS. 21A and 21B.

FIG. 21A is a diagram showing a result of the scheduling of the instruction sequence P2 shown in FIG. 2A in a case where the number of used processing elements is reduced as a priority, and in a case where the costs due to operation execution speed is reduced as a priority. Here, a result of the scheduling of the instruction sequence P2 shown in FIG. 2A in a case where the number of used processing elements is reduced as a priority is the same as a result of the scheduling in a case where the costs due to operation execution speed is reduced as a priority.

FIG. 21A shows assembler codes indicating the result of the scheduling of the instruction sequence P2 shown in FIG. 2A in a case where the number of used processing elements is reduced as a priority, and in a case where the costs due to operation execution speed is reduced as a priority. In FIG. 21A, a mark ;;(PARA) represents a split between cycles. In other words, an instruction sandwiched by the PARAs is executed in the same cycle. Operands of each instruction in FIG. 21A are rewritten from virtual registers to real registers. Furthermore, operands wire 11 in the instruction 4 and the instruction 5 indicate that an executed result is transferred between instructions within the same cycle without being stored in a register. The rewriting and the adding of the cycle split mark are performed by the instruction insert unit 17.

FIG. 21B is an image diagram of the result of the scheduling of the instruction sequence P2 shown in FIG. 2A in a case where the number of used processing elements is reduced as a priority, and in a case where the costs due to operation execution speed is reduced as a priority.

As shown in FIG. 21B, in the cycle 1, an addition instruction by the instruction 1 (addition) and a multiplication instruction by the instruction 2 (multiplication) are executed in parallel with each other. Furthermore, in the cycle 2, a shift instruction by the instruction 4 (shift) and an addition instruction by the instruction 5 (addition) are executed sequentially, and a multiplication instruction by the instruction 3 (multiplication) is executed in parallel with the addition instruction. Still further, in the cycle 3, only a multiplication instruction by the instruction 6 (multiplication) is executed. Thus, the multiplication instructions by the instruction 2 (multiplication), the instruction 3 (multiplication), and the instruction 6 (multiplication) are placed in different cycles, so that it is possible to reuse the multiplier. Moreover, the addition instructions by the instruction 1 (addition) and the instruction 5 (addition) are placed in different cycles, so that it is possible to reuse the adder. As described above, a necessary number of each processing element is one multiplier, one adder, and three shifters.

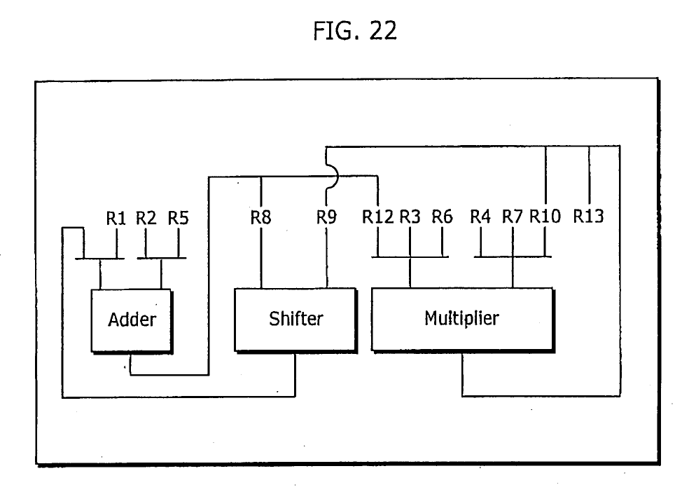

FIG. 22 is a block diagram showing a circuit formed based on the result of the scheduling of FIG. 21A. The circuit has one multiplier, one shifter, and one adder. It is seen that multiplication instructions by the instruction 2 (multiplication), the instruction 3 (multiplication) and the instruction 6 (multiplication) which are placed in different cycles by the scheduling use the same multiplier, and that addition instructions by the instruction 1 (addition), the instruction 5 (addition) use the same adder. Moreover, a result of a shift instruction by the instruction 4 (shift) is an input value for the instruction 5 (addition) which is placed in the same cycle of the instruction 4 (shift), so that the result is not stored in a register, but becomes a value to be inputted directly to the adder, and eventually one register is deleted.

As described above, according to the preferred embodiment of the present invention, the scheduling is performed to satisfy the execution efficiency designated by the user and at the same time to reduce averagely the used processing element number (per type) and the costs due to operation execution speed, thereby improving a reusability of the processing element and a usability of a low-cost processing element, so that it is possible to reduce circuit area and power consumption.

According to the instruction scheduling method and the instruction scheduling device of the present invention, a scheduling can be performed to satisfy execution efficiency designated by the user and at the same time to reduce averagely used processing element number (per type) and costs due to operation execution speed, thereby improving a reusability of the processing element and a usability of a low-cost processing element, so that it is possible to reduce circuit area and power consumption. The present invention is useful in the field of software language processing.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An instruction scheduling method for allocating each instruction included in an instruction sequence to be synthesized as a circuit to one of execution cycles in the circuit, said method comprising:
detecting a freedom of each instruction, the freedom representing a time period within which the instruction can be allocated;
calculating a load of a processing element corresponding to the instruction for each of the execution cycles; and
allocating the instructions using the same processing element within the freedoms to different execution cycles based on the load.

2. The instruction scheduling method according to claim 1, further comprising
determining number of the execution cycles in which the instruction sequence is allocated by receiving a user's designation of number of the execution cycles.

3. The instruction scheduling method according to claim 1, further comprising
receiving, on a type of the processing element, a designation of number of the processing elements,
wherein in said allocating, the instruction is allocated based on the designation of the number of the processing elements.

4. The instruction scheduling method according to claim 1, further comprising
receiving, on a type of the processing element, a designation of a limited number of the processing elements,
wherein in said allocating, the instruction is allocated in the processing element whose number is within the limited number.

5. The instruction scheduling method according to claim 1, further comprising
receiving a user's designation of a processing element whose cost is to be reduced,
wherein in said allocating, an instruction using the processing element designated by the user is allocated as a priority.

6. The instruction scheduling method according to claim 1, further comprising
receiving a user's designation of a priority of the processing element whose cost is to be reduced,
wherein in said allocating, an instruction using the processing element is allocated in order of the designated priority.

7. The instruction scheduling method according to claim 1, further comprising
selecting as a priority, based on a user's designation, one of number of used processing elements and a cost due to operation execution speed increase in order to be reduced,
wherein in said calculating, a first load of the number of used processing elements and a second load of the cost due to operation execution speed increase are calculated, and
in said allocating, the instruction using the processing element is allocated in order to reduce the selected load as a priority from the first load and the second load.

8. An instruction scheduling method for allocating each instruction included in an instruction sequence to be synthesized as a circuit to one of execution cycles in the circuit, said method comprising:
obtaining number of the execution cycles as execution efficiency of the circuit which is designated by a user;
creating a directed acyclic graph which indicates interdependencies among the instructions included in the instruction sequence; and
allocating each instruction to one of the execution cycles in order to satisfy the designated execution efficiency and to reduce number of processing elements and a cost due to operation execution speed increase,
wherein in said allocating includes:
determining a scheduling time range which represents a total number of the execution cycles in which the instruction sequence to be scheduled is to be allocated based on the execution efficiency;
setting, on a type of the processing element, a target number of the processing elements;
calculating a freedom of each instruction, the freedom representing a time period within which the instruction can be allocated within the scheduling time range based on a directed acyclic graph;
calculating a load of the processing element for each of the execution cycles; and
allocating each instruction to one of the execution cycles by determining an allocating time of the instruction within the freedom based on the target number of the processing elements and the calculated load.

9. The instruction scheduling method according to claim 8,
wherein in said determining, the number of the execution cycles which is designated by the user is determined as the scheduling time range.

10. The instruction scheduling method according to claim 8,
wherein said setting, for a certain type processing element of whose number is not designated by the user, the target number of the processing elements is obtained by dividing a total number of instructions using the by number of the execution cycles in the scheduling time range and then converting the divided value into an integer value.

11. The instruction scheduling method according to claim 8,
wherein in said setting, number of certain type processing elements whose number is designated by the user is set to as the target number of the processing elements.

12. The instruction scheduling method according to claim 8,
wherein in said calculating of the load,
a processing element number load and a minimum operation execution speed load are calculated, the processing element number load being an index for calculating an instruction allocating time in order to reduce the number of the processing elements, and the minimum operation execution speed load being an index for calculating an instruction allocating time in order to reduce the cost due to operation execution speed increase.

13. The instruction scheduling method according to claim 12,
wherein the minimum operation execution speed load is equivalent to an inverse number of a value of a maximum time period which is available to execute an instruction, in a case where the instruction is allocated in an execution cycle whose minimum operation execution speed load is to be calculated.

14. The instruction scheduling method according to claim 8,
wherein in said allocating, the allocating time is determined firstly for an instruction which uses a processing element whose processing element number load is larger than the target number of the processing elements in order to reduce number of the processing elements used in the whole instruction sequence.

15. The instruction scheduling method according to claim 14,
wherein in said allocating,
the freedom is changed firstly for an instruction which is selected from the instructions which use processing elements whose processing element number load is larger than the target number of the processing elements, based on a priority of the following conditions (a) and (b):
the conditions (a), in a case where an execution cycle whose processing element number load is larger than the target number of the processing elements is defined as an execution cycle for which the load is to be reduced and there is an instruction which has a possibility of being allocated in an execution cycle prior to the execution cycle, defining
(Priority 1) an instruction whose height is the highest,
(Priority 2) an instruction with a maximum number of child nodes,
(Priority 3) an instruction whose depth is the narrowest,
(Priority 4) an instruction with a minimum number of parent nodes, and
(Priority 5) an instruction with a minimum directed acyclic graph node identification; and
the conditions (b), in a case where there is no instruction which has a possibility of being allocated in an execution cycle prior to the execution cycle by which the load is to be reduced, defining
(Priority 1) an instruction whose height is the lowest,
(Priority 2) an instruction with a minimum number of child nodes,
(Priority 3) an instruction whose depth is the deepest,
(Priority 4) an instruction with a maximum number of parent nodes, and
(Priority 5) an instruction with a maximum directed acyclic graph node identification.

16. The instruction scheduling method according to claim 15,
wherein in said allocating,
in a case where an instruction whose freedom is firstly changed has a possibility of being allocated in an execution cycle prior to the execution cycle whose load is to be reduced, the freedom of the instruction is changed so that the instruction is allocated in an execution cycle immediately prior to the execution-cycle whose load is to be reduced, and
in a case where the instruction whose freedom is firstly changed does not a possibility of being allocated in an execution cycle prior to the execution cycle whose load is to be reduced, the freedom of the instruction is changed so that the instruction is allocated in an execution cycle immediately subsequent to the execution cycle whose load is to be reduced.

17. The instruction scheduling method according to claim 8,
wherein in said calculating of the load, a minimum operation execution speed load which is an index for calculating an instruction allocating time in order to reduce a cost due to operation execution speed increase is calculated and
in said allocating, the allocating time of the instruction is determined by using a target operation execution speed load which is an index for reducing a load of the cost due to operation execution speed increase,
wherein the target operation execution speed load is set to as a largest value of a minimum operation execution speed load among minimum values of minimum operation execution speed loads of instructions using a processing element whose operation execution speed load is to be reduced.

18. The instruction scheduling method according to claim 8, further comprising
rewriting two instructions in order to transfer a result of executing one instruction to another instruction without storing the result in a register, in a case where the result of executing the one instruction is used for the another instruction in a same execution cycle based on a result of said allocating of the instructions.

19. A circuit synthesizing method for synthesizing a circuit from an instruction sequence by allocating each instruction included in the instruction sequence to one of execution cycles in the circuit, said method comprising:
detecting a freedom of each instruction, the freedom representing a time period within which the instruction can be allocated;
calculating a load of a processing element corresponding to the instruction for each of the execution cycles; and
allocating the instructions using the same processing element within the freedoms to different execution cycles based on the load.

20. A program for performing an instruction scheduling method for allocating each instruction included in an instruction sequence to be synthesized as a circuit to one of execution cycles in the circuit, said program causing a computer to execute:
detecting a freedom of each instruction, the freedom representing a time period within which the single can be allocated;
calculating a load of a processing element corresponding to the instruction for each of the execution cycles; and
allocating the instructions using the same processing element within the freedoms to different execution cycles based on the load.
